(19) United States
(12) Patent Application Publication
(10) Pub. No.: US 2026/0281666 A1
(43) Pub. Date: Sep. 17, 2026

(54) ELECTRONIC DEVICE FOR PROVIDING AUDIO SERVICE, AND OPERATING METHOD THEREOF

(71) Applicant: SAMSUNG ELECTRONICS CO., LTD., Suwon-si (KR)

(72) Inventors: Byeonghoon AHN, Suwon-si (KR); Taekyung Kim, Suwon-si (KR); Seunguk Jang, Suwon-si (KR); Junho Jang, Suwon-si (KR)

(73) Assignee: SAMSUNG ELECTRONICS CO., LTD., Suwon-si (KR)

(21) Appl. No.: 19/679,281

(22) Filed: May 15, 2026

Related U.S. Application Data
(63) Continuation of application No. PCT/KR2024/017986, filed on Nov. 14, 2024.

(30) Foreign Application Priority Data
Nov. 16, 2023 (KR) 10-2023-0159317
Jan. 25, 2024 (KR) 10-2024-0011479

(51) Int. Cl. H04W 4/06; H04W 4/80

(52) U.S. Cl. CPC H04W 4/06; H04W 4/80

(57) ABSTRACT

An electronic device may include communication circuitry; one or more processors; and memory storing instructions. The instructions, when executed by the one or more processors, may cause the electronic device to: receive, via the communication circuitry, information corresponding to a broadcast isochronous group (BIG) from an external electronic device, store, in the memory, the information corresponding to the BIG, based on the information corresponding to the BIG, perform, via the communication circuitry, a first synchronization operation for at least one broadcast isochronous stream (BIS) broadcast by the external electronic device, based on receiving audio data via the at least one BIS, detect a BIG asynchronous event corresponding to an asynchronous state for the BIG, and based on the BIG asynchronous event, perform, via the communication circuitry, a second synchronization operation for the at least one BIS based on the stored information related to the BIG.

### CROSS-REFERENCE TO RELATED APPLICATIONS

This application is a Continuation Application of International Application PCT/KR2024/017986, filed on Nov. 14, 2024, which claims priority to Korean Patent Application No. 10-2023-0159317, filed on Nov. 16, 2023, at the Korean Ministry of Intellectual Property and Korean Patent Application No. 10-2024-0011479, filed on Jan. 25, 2024, at the Korean Ministry of Intellectual Property, the disclosures of which are incorporated herein in their entireties by reference.

### BACKGROUND

### 1. Field

The disclosure relates to an electronic device providing an audio service and an operating method thereof.

### 2. Description of the Related Art

Recently, with the development of an information communication technology, various wireless communication technologies and various services have been developed. In particular, a Bluetooth scheme which is one of short-range communication schemes has been actively used, and electronic devices using the Bluetooth scheme have been also widely used. In particular, a pair of earbuds which may be worn on both ears of a user have been widely used as an ear-wearable device. The ear-wearable device may provide various functions. For example, the ear-wearable device may input and identify a voice of the user using a microphone, transmit audio data related to the voice of the user to an electronic device (e.g., a smartphone), and output audio data received from the electronic device using a speaker.

The Bluetooth scheme may include a Bluetooth legacy (or Bluetooth classic) scheme and/or a Bluetooth low energy (BLE) scheme. The first external electronic device (e.g., the ear-wearable device) which provides a low energy audio (LE Audio) service based on the BLE scheme may independently establish a communication link with the electronic device (e.g., the smart phone), and transmit and receive data to and from the electronic device via the established communication link.

The audio service based on the BLE scheme may be provided via a connection-based connected isochronous stream (CIS) or a non-connection-based broadcast isochronous stream (BIS). If a multi-party audio service is provided via the CIS, all electronic devices participating in the multi-party audio service establish BLE links to each other, and establish CISs based on the established BLE links. If the number of electronic devices participating in a CIS-based multi-party audio service increases, the number of links which need to be established between the electronic devices participating in the CIS-based multi-party audio service may increase exponentially, and this exponential increase in the number of links may make it difficult to provide the CIS-based multi-party audio service and may also make it impossible for the CIS-based multi-party audio service to be provided.

Alternatively, if the multi-party audio service is provided via the BIS, there is no limitation on the number of electronic devices participating in the multi-party audio service, so the audio service may be provided normally even if the number of electronic devices participating in the multi-party audio service increases exponentially.

### SUMMARY

According to one or more embodiments of the disclosure, an electronic device (101; 200) may comprise communication circuitry (190; 302), one or more processors (120; 304) including processing circuitry, and memory (130; 306) storing instructions.

According to one or more embodiments of the disclosure, the instructions, when executed by the one or processors individually or collectively, may cause the electronic device to receive information corresponding to a broadcast isochronous group (BIG) from an external electronic device (210) via the communication circuitry.

According to one or more embodiments of the disclosure, the instructions, when executed by the one or processors individually or collectively, may cause the electronic device to store the information corresponding to the BIG in the memory.

According to one or more embodiments of the disclosure, the instructions, when executed by the one or processors individually or collectively, may cause the electronic device to, based on the information corresponding to the BIG, perform, via the communication circuitry, a synchronization operation for at least one broadcast isochronous stream (BIS) provided by the external electronic device.

According to one or more embodiments of the disclosure, the instructions, when executed by the one or processors individually or collectively, may cause the electronic device to receive, via the communication circuitry, audio data via the at least one BIS.

According to one or more embodiments of the disclosure, the instructions, when executed by the one or processors individually or collectively, may cause the electronic device to, based on receiving the audio data, detect a BIG asynchronous event corresponding to an asynchronous state for the BIG.

According to one or more embodiments of the disclosure, the instructions, when executed by the one or processors individually or collectively, may cause the electronic device to, based on the BIG asynchronous event, perform, via the communication circuitry, a second synchronization operation for the at least one BIS based on the stored information corresponding to the BIG.

According to one or more embodiments of the disclosure, an electronic device (200) may comprise communication circuitry (302), one or more processors (304) including processing circuitry, and memory (306) storing instructions.

According to one or more embodiments of the disclosure, the instructions, when executed by the one or processors individually or collectively, may cause the electronic device to establish, via the communication circuitry, a connection with a first external electronic device (101).

According to one or more embodiments of the disclosure, the instructions, when executed by the one or processors individually or collectively, may cause the electronic device to receive information corresponding to a second external electronic device (210) from the first external electronic device via the communication circuitry.

According to one or more embodiments of the disclosure, the instructions, when executed by the one or processors individually or collectively, may cause the electronic device to, based on the information corresponding to the second external electronic device, receive information corresponding to a BIG from the second external electronic device via the communication circuitry.

According to one or more embodiments of the disclosure, the instructions, when executed by the one or processors individually or collectively, may cause the electronic device to store the information corresponding to the BIG in the memory.

According to one or more embodiments of the disclosure, the instructions, when executed by the one or processors individually or collectively, may cause the electronic device to, based on the information corresponding to the BIG, perform, via the communication circuitry, a synchronization operation for at least one BIS provided by the second external electronic device.

According to one or more embodiments of the disclosure, the instructions, when executed by the one or processors individually or collectively, may cause the electronic device to receive, via the communication circuitry, audio data via the at least one BIS.

According to one or more embodiments of the disclosure, the instructions, when executed by the one or processors individually or collectively, may cause the electronic device to, based on receiving the audio data, detect a BIG asynchronous event corresponding to an asynchronous state for the BIG.

According to one or more embodiments of the disclosure, the instructions, when executed by the one or processors individually or collectively, may cause the electronic device to, based on the BIG asynchronous event, perform, via the communication circuitry, a second synchronization operation for the at least one BIS based on the stored information corresponding to the BIG.

According to one or more embodiments of the disclosure, a method of an electronic device (101; 200) may comprise receiving information corresponding to a BIG from an external electronic device (210) via the communication circuitry.

According to one or more embodiments of the disclosure, the method may comprise storing the information corresponding to the BIG.

According to one or more embodiments of the disclosure, the method may comprise, based on the information corresponding to the BIG, performing a synchronization operation for at least one BIS provided by the external electronic device.

According to one or more embodiments of the disclosure, the method may comprise receiving audio data via the at least one BIS.

According to one or more embodiments of the disclosure, the method may comprise, while receiving the audio data, detecting a BIG asynchronous event corresponding to an asynchronous state for the BIG.

According to one or more embodiments of the disclosure, the method may comprise, based on the BIG asynchronous event, performing a second synchronization operation for the at least one BIS based on the stored information corresponding to the BIG.

According to one or more embodiments of the disclosure, a method may comprise establishing a connection with a first external electronic device (101).

According to one or more embodiments of the disclosure, the method may comprise receiving information corresponding to a second external electronic device (210) from the first external electronic device.

According to one or more embodiments of the disclosure, the method may comprise, based on the information corresponding to the second external electronic device, receiving information corresponding to a BIG from the second external electronic device.

According to one or more embodiments of the disclosure, the method may comprise storing the information corresponding to the BIG.

According to one or more embodiments of the disclosure, the method may comprise, based on the information corresponding to the BIG, performing a synchronization operation for at least one BIS provided by the second external electronic device.

According to one or more embodiments of the disclosure, the method may comprise receiving audio data via the at least one BIS.

According to one or more embodiments of the disclosure, the method may comprise, while receiving the audio data, detecting a BIG asynchronous event corresponding to an asynchronous state for the BIG.

According to one or more embodiments of the disclosure, the method may comprise, based on the BIG asynchronous event, performing the synchronization operation for the at least one BIS based on the stored information corresponding to the BIG.

According to one or more embodiments of the disclosure, a storage medium storing at least one instruction readable by a computer may be provided.

According to one or more embodiments of the disclosure, the at least one instruction, when executed by a processor (120; 304) including processing circuitry of an electronic device (101), may cause the electronic device to perform at least one operation.

According to one or more embodiments of the disclosure, the at least one operation may comprise receiving information corresponding to a BIG from an external electronic device (210).

According to one or more embodiments of the disclosure, the at least one operation may comprise storing the information corresponding to the BIG.

According to one or more embodiments of the disclosure, the at least one operation may comprise, based on the information corresponding to the BIG, performing a synchronization operation for at least one BIS broadcast by the external electronic device

According to one or more embodiments of the disclosure, the at least one operation may comprise receiving audio data via the at least one BIS.

According to one or more embodiments of the disclosure, the at least one operation may comprise, based on receiving the audio data, detecting a BIG asynchronous event corresponding to an asynchronous state for the BIG.

According to one or more embodiments of the disclosure, the at least one operation may comprise, based on the BIG asynchronous event, performing a second synchronization operation for the at least one BIS based on the stored information corresponding to the BIG.

According to one or more embodiments of the disclosure, a storage medium storing at least one instruction readable by a computer may be provided.

According to one or more embodiments of the disclosure, the at least one instruction, when executed by a processor (304) including processing circuitry of an electronic device (200), may cause the electronic device to perform at least one operation.

According to one or more embodiments of the disclosure, the at least one operation may comprise establishing a connection with a first external electronic device (101).

According to one or more embodiments of the disclosure, the at least one operation may comprise receiving information corresponding to a second external electronic device (210) from the first external electronic device.

According to one or more embodiments of the disclosure, the at least one operation may comprise, based on the information corresponding to the second external electronic device, receiving information corresponding to a BIG from the second external electronic device.

According to one or more embodiments of the disclosure, the at least one operation may comprise storing the information corresponding to the BIG.

According to one or more embodiments of the disclosure, the at least one operation may comprise, based on the information corresponding to the BIG, performing a synchronization operation for at least one BIS provided by the second external electronic device.

According to one or more embodiments of the disclosure, the at least one operation may comprise receiving audio data via the at least one BIS.

According to one or more embodiments of the disclosure, the at least one operation may comprise, based on receiving the audio data, detecting a BIG asynchronous event corresponding to an asynchronous state for the BIG.

According to one or more embodiments of the disclosure, the at least one operation may comprise, based on the BIG asynchronous event, performing the synchronization operation for the at least one BIS based on the stored information corresponding to the BIG.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram schematically illustrating an electronic device within a network environment according to one or more embodiments;

FIG. 2 is a diagram schematically illustrating connections between electronic devices which are based on a Bluetooth scheme in a wireless communication network according to one or more embodiments;

FIG. 3 is a block diagram schematically illustrating an external electronic device in a wireless communication network according to one or more embodiments;

FIG. 4 is a diagram schematically illustrating configuration of BIG events and BIS events in a wireless communication network according to one or more embodiments;

FIG. 5 is a flowchart schematically illustrating a method of operating an electronic device according to one or more embodiments;

FIG. 6 is a flowchart schematically illustrating a method of operating a first external electronic device according to one or more embodiments;

FIG. 7 is a diagram for describing a PA operation performed by a second external electronic device according to one or more embodiments;

FIG. 8 is a diagram illustrating a format of BIGInfo;

FIG. 9 is a diagram for describing a time reference of a BIG event from a PA event;

FIG. 10 is a signal flowchart illustrating an operation in which a first external electronic device synchronizes with a BIS of a second external electronic device according to one or more embodiments;

FIG. 11 is a diagram for describing an event in which synchronization with a BIS is lost; and

FIG. 12 is a flowchart schematically illustrating a method of operating an electronic device according to one or more embodiments.

### DETAILED DESCRIPTION

Hereinafter, one or more embodiments of the disclosure will be described in detail with reference to the accompanying drawings. In the following description of one or more embodiments of the disclosure, a detailed description of relevant known functions or configurations incorporated herein will be omitted when it is determined that the description may make the subject matter of one or more embodiments of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

It should be noted that the technical terms used herein are only used to describe specific embodiments, and are not intended to limit one or more embodiments of the disclosure. Alternatively, the technical terms used herein should be interpreted to have the same meaning as those commonly understood by a person skilled in the art to which the disclosure pertains, and should not be interpreted have excessively comprehensive or excessively restricted meanings unless particularly defined as other meanings. Alternatively, when the technical terms used herein are wrong technical terms that cannot correctly represent the idea of the disclosure, it should be appreciated that they are replaced by technical terms correctly understood by those skilled in the art. Alternatively, the general terms used in one or more embodiments of the disclosure should be interpreted as defined in dictionaries or interpreted in the context of the relevant part, and should not be interpreted to have excessively restricted meanings.

Alternatively, a singular expression used herein may include a plural expression unless they are definitely different in the context. As used herein, such an expression as “comprises” or “include”, or the like should not be interpreted to necessarily include all elements or all operations described in the specification, and should be interpreted to be allowed to exclude some of them or further include additional elements or operations.

Alternatively, the terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any number of elements may be interposer between them. In contrast, it should be understood that when an element is referred to as being “directly connected” or “directly coupled” to another element, there are no element interposed between them.

Hereinafter, one or more embodiments of the disclosure will be described in detail with reference to the accompanying drawings. Regardless of drawing signs, the same or like elements are provided with the same reference numeral, and a repeated description thereof will be omitted. Alternatively, in describing one or more embodiments of the disclosure, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, one or more embodiments of the disclosure will describe an electronic device, but the electronic device may be referred to as a terminal, a mobile station, a mobile equipment (ME), a user equipment (UE), a user terminal (UT), a subscriber station (SS), a wireless device, a handheld device, and an access terminal (AT). Alternatively, in one or more embodiments of the disclosure, the electronic device may be a device having a communication function such as, for example, a mobile phone, a personal digital assistant (PDA), a smart phone, a wireless MODEM, and a notebook.

In a detailed description of one or more embodiments of the disclosure, a standard specified by Bluetooth special interest group (SIG) is referred to, but the main subject of the disclosure can be somewhat modified and applied to other communication systems having a similar technical background without departing from the scope of the disclosure, and the modifications can be made on the basis of determination of those skilled in the art.

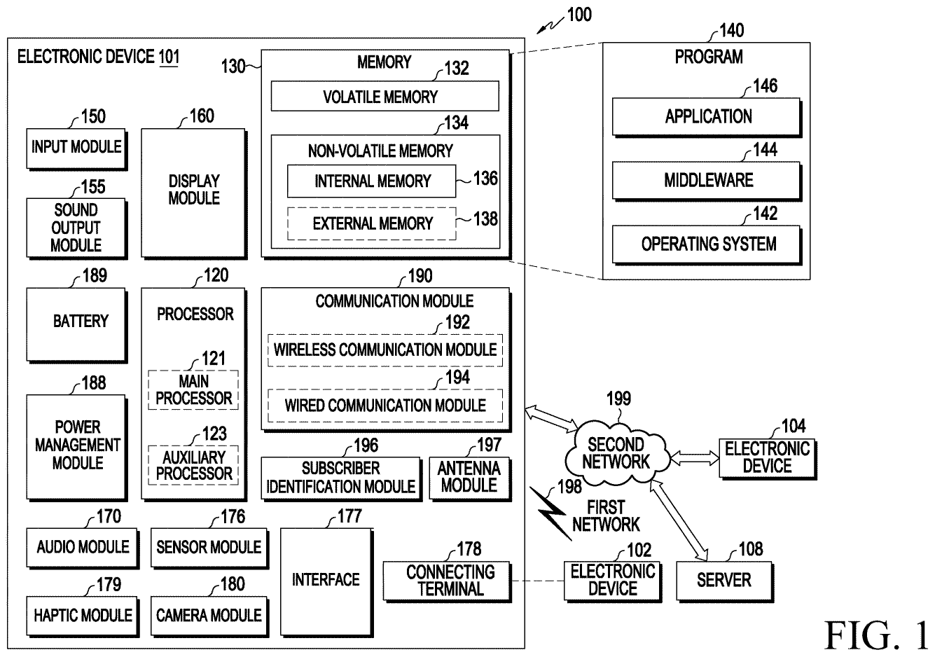

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

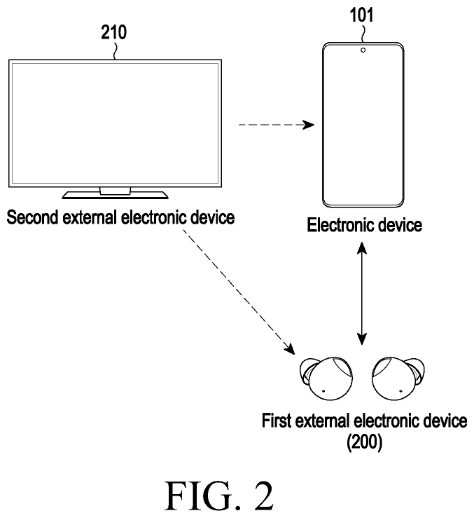

FIG. 2 is a diagram schematically illustrating connections between electronic devices which are based on a Bluetooth scheme in a wireless communication network according to one or more embodiments.

Referring to FIG. 2, an electronic device 101 (e.g., an electronic device 101 in FIG. 1) may be wirelessly and/or wiredly connected to a plurality of external electronic devices. The plurality of external electronic devices (e.g., an electronic device 102 or an electronic device 104 in FIG. 1) may include a first external electronic device 200 and/or a second external electronic device 210.

For example, the electronic device 101 may be a smartphone. The first external electronic device 200 may be an ear-wearable device and/or a speaker. The first external electronic device 200 may include a first earbud (e.g., a left earbud) and/or a second earbud (e.g., a right earbud). The second external electronic device 210 may be a TV or another smartphone.

In an one or more embodiments, the electronic device 101, the first external electronic device 200, and/or the second external electronic device 210 may provide an audio service based on a Bluetooth scheme. In one or more embodiments, the Bluetooth scheme may include a Bluetooth legacy (or Bluetooth classic) scheme, and/or a Bluetooth low energy (BLE) scheme.

According to one or more embodiments, the electronic device 101 and the first external electronic device 200 may establish a connection (e.g., a communication link) with each other, and may transmit and/or receive data with each other via the established connection. For example, the electronic device 101 and the first external electronic device 200 may establish a communication link based on at least one of a Wi-Fi scheme and/or the Bluetooth scheme, but a scheme by which the electronic device 101 and the first external electronic device 200 establish the communication link is not limited to only at least one of the Wi-Fi scheme and/or the Bluetooth scheme.

According to one or more embodiments, the electronic device 101 may operate as a broadcast assistant device and discover audio capabilities of the first external electronic device 200, a broadcast audio stream, and/or data for describing a configuration for the broadcast audio stream transmitted by the first external electronic device 200. According to one or more embodiments, the electronic device 101 may perform a scan operation to obtain synchronization information (SyncInfo) included in an AUX_ADV_IND protocol data unit (PDU) transmitted based on extended advertising (EA) performed in the first external electronic device 200. The electronic device 101 may identify audio capabilities via periodic advertising (PA) performed in the first external electronic device 200 based on the obtained SyncInfo.

In one or more embodiments, the first external electronic device 200 may operate as a broadcast sink device and a scan delegator device. The first external electronic device 200 may be connected to the electronic device 101 or may provide an audio service by being synchronized with the electronic device 101. In one or more embodiments, the scan delegator device may perform a role for delegating a scan-related operation to a broadcast assistant device, and the broadcast assistant device may provide, to the scan delegator device, information about a broadcast source device which the broadcast assistant device will scan and receive on behalf of the scan delegator device and a broadcast code.

The first external electronic device 200 may be synchronized with the second external electronic device 210 which operates as a broadcast source device. The first external electronic device 200 may discover or receive data for describing a configuration of a broadcast audio stream, and/or the broadcast audio stream. The first external electronic device 200 may transmit (for example, may broadcast) an audio capability. The first external electronic device 200 may request the electronic device 101 which operates as a broadcast assistant device to perform a scan operation on behalf of the first external electronic device 200. The first external electronic device 200 may receive, from the electronic device 101, data which the electronic device 101 scans on behalf of the first external electronic device 200.

In one or more embodiments, the second external electronic device 210 may operate as a broadcast source device. In one or more embodiments, the broadcast source device may be a device which transmits (for example, broadcasts) a broadcast isochronous stream (BIS). In one or more embodiments, the broadcast source device may generate a broadcast isochronous group (BIG) including a plurality of (e.g., N) BISes. The broadcast source device may transmit a plurality of audio channel signals via the plurality of BISs, and a BIS index may be assigned to each BIS. The broadcast source device may advertise information related to the BISs included in the BIG. In one or more embodiments, the broadcast source device may advertise information related to the BIG and the BISs via periodic advertising (PA).

The electronic device 101 may operate as a broadcast assistant device. In one or more embodiments, the broadcast assistant device may monitor information related to BISs transmitted from a broadcast source device. In one or more embodiments, the broadcast assistant device may receive a PDU according to PA performed by the broadcast source device based on a set period to identify information related to BISes transmitted by the broadcast source device. In one or more embodiments, the broadcast assistant device may determine a BIS to be received from at least one of a plurality of broadcast sink devices connected to the broadcast assistant device based on the monitored information. The broadcast assistant device may transmit a determined BIS index to the broadcast sink device so that the broadcast sink device may receive the BIS determined by the broadcast assistant device and output audio data of an audio channel corresponding to the received BIS. In one or more embodiments, the electronic device 101 may broadcast control information including an index of the broadcast sink device and the BIS index determined for the broadcast sink device via the periodic advertising, and the broadcast sink device may receive the control information broadcast by the electronic device 101 and receive the BIS corresponding to the BIS index determined by the electronic device 101. In one or more embodiments, the broadcast assistant device may transmit the determined BIS index to the broadcast sink device via a connection (e.g., a communication link) established between the broadcast assistant device and the broadcast sink device. In one or more embodiments, the broadcast assistant device may also change the BIS determined for the at least one of the plurality of broadcast sink devices. The broadcast assistant device may transmit the changed BIS index to the broadcast sink device so that the broadcast sink device may receive a BIS index changed by the broadcast assistant device and output audio data of an audio channel corresponding to the received BIS index.

In one or more embodiments, the first external electronic device 200 may operate as a broadcast sink device. The broadcast sink device may receive BISs transmitted from a broadcast source device. According to one or more embodiments, the broadcast sink device may receive a BIS determined by a broadcast assistant device among the BISs transmitted from the broadcast source device, and output audio data of an audio channel corresponding to the received BIS. The broadcast sink device may receive a BIS index corresponding to a BIS which the broadcast sink device will receive from the broadcast assistant device via a connection (e.g., a communication link) established between the broadcast sink device and the broadcast assistant device. The broadcast sink device may receive the BIS corresponding to the BIS index received from the broadcast assistant device, and while outputting the audio data of the audio channel corresponding to the received BIS, may identify that a BIS which the broadcast sink device needs to receive from the broadcast assistant device is changed. The broadcast sink device may receive the changed BIS index which the broadcast sink device needs to receive from the broadcast assistant device while outputting the audio data, and receive a BIS corresponding to the changed BIS index.

In FIG. 2, a case that the second external electronic device 210 operates as the broadcast source device and the electronic device 101 operates as the broadcast assistant device has been described as an example, however, the electronic device 101 may operate as the broadcast source device while also operating as the broadcast assistance device.

The first external electronic device 200 may receive a corresponding BIS based on information broadcasted via the periodic advertising in the electronic device 101 and output audio data of the received BIS.

In FIG. 2, a case that the electronic device 101 and the first external electronic device 200 establish the connection has been described as an example, but the electronic device 101 may establish a connection not only with the first external electronic device 200 but also with at least one other external electronic device.

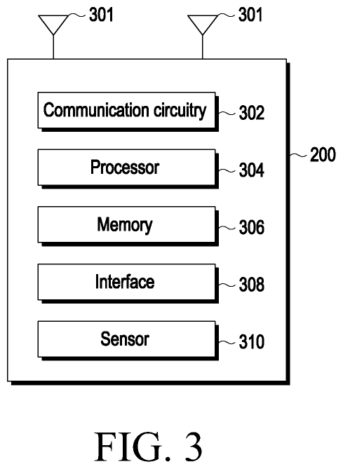

FIG. 3 is a block diagram schematically illustrating an external electronic device in a wireless communication network according to one or more embodiments.

Referring to FIG. 3, a first external electronic device 200 (e.g., an electronic device 104 in FIG. 1 or a first external electronic device 200 in FIG. 2) may be a device implementing a Bluetooth scheme (e.g., a Bluetooth legacy scheme and/or a BLE scheme). The first external electronic device 200 may include communication circuitry 302 which transmits and receives signals with an electronic device (e.g., an electronic device 101 in FIG. 1 or FIG. 2), for example, a peer device and/or another electronic device (e.g., a second external electronic device 210 in FIG. 2) by using one or more antennas 301.

The first external electronic device 200 may include a processor 304 which may be implemented in one or more single-core processors or one or more multi-core processors, and memory 306 which stores instructions for an operation of the first external electronic device 200.

The first external electronic device 200 may include an interface module 308 which provides a wired and/or wireless interface for communicating with components outside a network.

According to one or more embodiments, the first external electronic device 200 may include a plurality of communication circuits, one of the plurality of communication circuits may be communication circuitry which is based on a Wi-Fi scheme, and another of the plurality of communication circuits may be communication circuitry which is based on a Bluetooth scheme, e.g., a BLE scheme. According to one or more embodiments, the plurality of communication circuits may include the communication circuitry 302, and the communication circuitry 302 may be communication circuitry which is based on the Wi-Fi scheme or communication circuitry which is based on the BLE scheme.

According to one or more embodiments, the first external electronic device 200 does not separately include communication circuitry which is based on the Wi-Fi scheme and communication circuitry which is based on the BLE scheme, and may include one communication circuit capable of supporting both the Wi-Fi scheme and the BLE scheme. According to one or more embodiments, the one communication circuit capable of supporting both the Wi-Fi scheme and the BLE scheme may be the communication circuitry 302.

According to one or more embodiments, the first external electronic device 200 may include a sensor 310, and the sensor 310 may detect an operational state (e.g., power or temperature) of the electronic device 101 or an environmental state (e.g., a state of a user) external to the electronic device 101, and then generate an electrical signal or data value corresponding to the detected state. According to one or more embodiments, the sensor 310 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor. According to one or more embodiments, the sensor 310 may detect a state corresponding to a user input.

The Bluetooth scheme may include a Bluetooth legacy (or Bluetooth classic) scheme and/or a Bluetooth low energy (BLE) scheme. An electronic device (e.g., an electronic device 101 in FIG. 1 or FIG. 2) (e.g., a smart phone) that provides an audio service based on the BLE scheme may independently establish a connection (e.g., a communication link) with each of a plurality of external electronic devices (e.g., an electronic device 102 or an electronic device 104 in FIG. 1, a first external electronic device 211 in FIG. 2, or a second external electronic device 210 in FIG. 2), and transmit and receive data to and from the external electronic devices via the established connection.

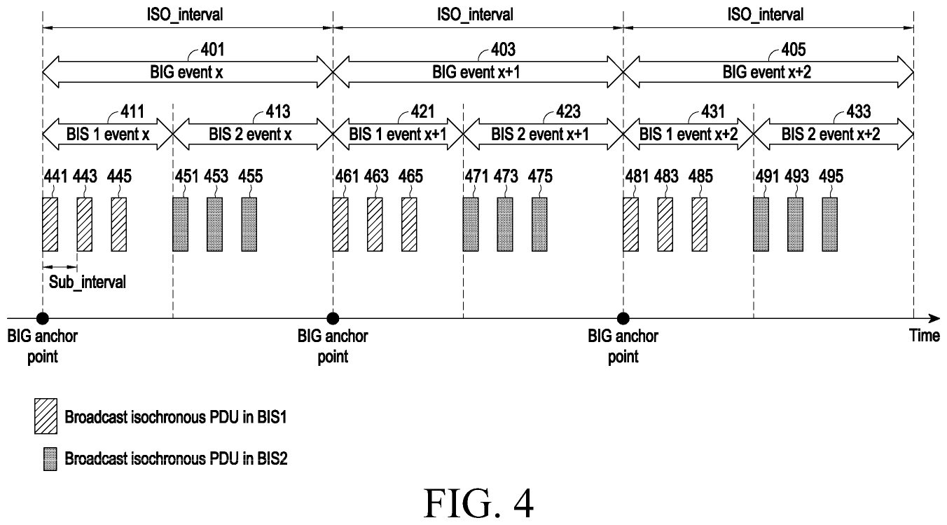

FIG. 4 is a diagram schematically illustrating configuration of BIG events and BIS events in a wireless communication network according to one or more embodiments.

Referring to FIG. 4, each of BIG events (e.g., a BIG event x 401, a BIG event x+1 403, and a BIG event x+2 403) may include two BIS events. For example, the BIG event x 401 may include a BIS1 event x 411 and a BIS2 event x 413, the BIG event x+1 403 may include a BIS1 event x+1 421 and a BIS2 event x+1 423, and the BIG event x+2 405 may include a BIS1 event x+2 431 and a BIS2 event x+2 433.

A BIG event may include one or more BIS protocol data units (PDUs). A link layer may transmit BIS PDUs only in BIG events. The link layer may transmit only BIS PDUs as part of the BIG event. Each BIG event may be divided into Num_BIS BIS events and a control subevent (if present). Each BIS event may be divided into NSE subevents. Each BIS event starts at a moment called BIS anchor point and ends after the last subevent of each BIS event. Each BIG event starts at a moment called BIG anchor point, and ends after one control subevent if there is the one control subevent, and otherwise, at the end of the last constituent BIS event.

BIG anchor points may be spaced regularly at ISO_Intervals. BIS anchor points for a BIS n of a BIG may be (n−1) X BIS_Spacing after the BIG anchor points, so may be also spaced regularly, ISO_Interval apart. BIS_Spacing may be time between start of subevents in adjacent BISes included in the BIG and also time between start of the first subevent of the last BIS and a control subevent. Subevents of each BIS may be Sub_Interval apart. The Isochronous broadcaster may terminate each BIG event at least T_IFS before a BIG anchor point of the next BIG event. T_IFS may represent a time inter frame space and indicate a time interval between consecutive packets on the same channel index.

In the BIS1 event x 411, a broadcast isochronous PDU 441, a broadcast isochronous PDU 443, and a broadcast isochronous PDU 445 may be transmitted.

In the BIS2 event x 413, a broadcast isochronous PDU 451, a broadcast isochronous PDU 453, and a broadcast isochronous PDU 455 may be transmitted.

In the BIS1 event x+1 421, a broadcast isochronous PDU 461, a broadcast isochronous PDU 463, and a broadcast isochronous PDU 465 may be transmitted.

In the BIS2 event x+1 423, a broadcast isochronous PDU 471, a broadcast isochronous PDU 473, and a broadcast isochronous PDU 475 may be transmitted.

In the BIS1 event x+2 431, a broadcast isochronous PDU 481, a broadcast isochronous PDU 483, and a broadcast isochronous PDU 485 may be transmitted.

In the BIS2 event x+2 433, a broadcast isochronous PDU 491, a broadcast isochronous PDU 493, and a broadcast isochronous PDU 495 may be transmitted.

According to one or more embodiments of the disclosure, an electronic device (101; 200) may comprise communication circuitry (190; 302), one or more processors (120; 304) including processing circuitry, and memory (130; 306) storing instructions.

According to one or more embodiments of the disclosure, the instructions, when executed by the one or processors individually or collectively, may cause the electronic device to receive information related to a BIG from an external electronic device (210) via the communication circuitry.

According to one or more embodiments of the disclosure, the instructions, when executed by the one or processors individually or collectively, may cause the electronic device to store the information related to the BIG in the memory.

According to one or more embodiments of the disclosure, the instructions, when executed by the one or processors individually or collectively, may cause the electronic device to, based on the information related to the BIG, perform, via the communication circuitry, a synchronization operation for at least one BIS provided by the external electronic device.

According to one or more embodiments of the disclosure, the instructions, when executed by the one or processors individually or collectively, may cause the electronic device to receive, via the communication circuitry, audio data via the at least one BIS.

According to one or more embodiments of the disclosure, the instructions, when executed by the one or processors individually or collectively, may cause the electronic device to, while receiving the audio data, detect a BIG asynchronous event related to an asynchronous state for the BIG.

According to one or more embodiments of the disclosure, the instructions, when executed by the one or processors individually or collectively, may cause the electronic device to, based on the BIG asynchronous event, perform, via the communication circuitry, the synchronization operation for the at least one BIS based on the stored information related to the According to one or more embodiments of the disclosure, the instructions, when executed by the one or processors individually or collectively, may cause the electronic device to identify whether synchronization with the at least one BIS is successful according to the synchronization operation for the at least one BIS which is based on the stored information related to the BIG.

According to one or more embodiments of the disclosure, the instructions, when executed by the one or processors individually or collectively, may cause the electronic device to, based on identifying that the synchronization to the at least one BIS is successful, receive audio data via the at least one BIS.

According to one or more embodiments of the disclosure, the instructions, when executed by the one or processors individually or collectively, may cause the electronic device to, based on identifying that the synchronization with the at least one BIS has failed, receive information related to a new BIG from the external electronic device via the communication circuitry.

According to one or more embodiments of the disclosure, the instructions, when executed by the one or processors individually or collectively, may cause the electronic device to, based on the information related to the new BIG, perform, via the communication circuitry, the synchronization operation for the at least one BIS.

According to one or more embodiments of the disclosure, the instructions, when executed by the one or processors individually or collectively, may cause the electronic device to, based on identifying that the synchronization with the at least one BIS has failed, identify whether a number of synchronization operations performed by the electronic device reaches a set number of times for the synchronization operation for the at least one BIS.

According to one or more embodiments of the disclosure, the instructions, when executed by the one or processors individually or collectively, may cause the electronic device to, based on identifying that it has not reached the set number of times, perform, via the communication circuitry, the synchronization operation for the at least one BIS based on the stored information related to the BIG.

According to one or more embodiments of the disclosure, the instructions, when executed by the one or processors individually or collectively, may cause the electronic device to, based on identifying that the number of synchronization operations performed by the electronic device has not reached the set number of times, receive, from the external electronic device via the communication circuitry, information related to a new BIG while performing the synchronization operation for the at least one BIS based on the stored information related to the BIG.

According to one or more embodiments of the disclosure, the instructions, when executed by the one or processors individually or collectively, may cause the electronic device to, based on the information related to the new BIG, perform, via the communication circuitry, the synchronization operation for the at least one BIS.

According to one or more embodiments of the disclosure, the instructions, when executed by the one or processors individually or collectively, may cause the electronic device to, based on identifying that the number of synchronization operations performed by the electronic device has reached the set number of times, receive, from the external electronic device via the communication circuitry, information related to a new BIG.

According to one or more embodiments of the disclosure, the instructions, when executed by the one or processors individually or collectively, may cause the electronic device to, based on the information related to the new BIG, perform, via the communication circuitry, the synchronization operation for the at least one BIS.

According to one or more embodiments of the disclosure, the BIG asynchronous event may include at least one of an event in which synchronization with the at least one BIS is lost, or an event in which a request to stop receiving the audio data via the at least one BIS is identified.

According to one or more embodiments of the disclosure, the event in which the synchronization with the at least one BIS is lost may be detected if the audio data is not successfully received via the at least one BIS for set time.

According to one or more embodiments of the disclosure, an electronic device (200) may comprise communication circuitry (302), one or more processors (304) including processing circuitry, and memory (306) storing instructions.

According to one or more embodiments of the disclosure, the instructions, when executed by the one or processors individually or collectively, may cause the electronic device to establish, via the communication circuitry, a connection with a first external electronic device (101).

According to one or more embodiments of the disclosure, the instructions, when executed by the one or processors individually or collectively, may cause the electronic device to receive information about a second external electronic device (210) from the first external electronic device via the communication circuitry.

According to one or more embodiments of the disclosure, the instructions, when executed by the one or processors individually or collectively, may cause the electronic device to, based on the information about the second external electronic device, receive information related to a BIG from the second external electronic device via the communication circuitry.

According to one or more embodiments of the disclosure, the instructions, when executed by the one or processors individually or collectively, may cause the electronic device to store the information related to the BIG in the memory.

According to one or more embodiments of the disclosure, the instructions, when executed by the one or processors individually or collectively, may cause the electronic device to, based on the information related to the BIG, perform, via the communication circuitry, a synchronization operation for at least one BIS provided by the second external electronic device.

According to one or more embodiments of the disclosure, the instructions, when executed by the one or processors individually or collectively, may cause the electronic device to receive, via the communication circuitry, audio data via the at least one BIS.

According to one or more embodiments of the disclosure, the instructions, when executed by the one or processors individually or collectively, may cause the electronic device to, while receiving the audio data, detect a BIG asynchronous event related to an asynchronous state for the BIG.

According to one or more embodiments of the disclosure, the instructions, when executed by the one or processors individually or collectively, may cause the electronic device to, based on the BIG asynchronous event, perform, via the communication circuitry, the synchronization operation for the at least one BIS based on the stored information related to the BIG.

According to one or more embodiments of the disclosure, the instructions, when executed by the one or processors individually or collectively, may cause the electronic device to identify whether synchronization with the at least one BIS is successful according to the synchronization operation for the at least one BIS which is based on the stored information related to the BIG.

According to one or more embodiments of the disclosure, the instructions, when executed by the one or processors individually or collectively, may cause the electronic device to, based on identifying that the synchronization to the at least one BIS is successful, receive audio data via the at least one BIS.

According to one or more embodiments of the disclosure, the instructions, when executed by the one or processors individually or collectively, may cause the electronic device to, based on identifying that the synchronization with the at least one BIS has failed, receive information related to a new BIG from the second external electronic device via the communication circuitry.

According to one or more embodiments of the disclosure, the instructions, when executed by the one or processors individually or collectively, may cause the electronic device to, based on the information related to the new BIG, perform, via the communication circuitry, the synchronization operation for the at least one BIS.

According to one or more embodiments of the disclosure, the instructions, when executed by the one or processors individually or collectively, may cause the electronic device to, based on identifying that the synchronization with the at least one BIS has failed, identify whether a number of synchronization operations performed by the electronic device reaches a set number of times for the synchronization operation for the at least one BIS.

According to one or more embodiments of the disclosure, the instructions, when executed by the one or processors individually or collectively, may cause the electronic device to, based on identifying that it has not reached the set number of times, perform, via the communication circuitry, the synchronization operation for the at least one BIS based on the stored information related to the BIG.

According to one or more embodiments of the disclosure, the instructions, when executed by the one or processors individually or collectively, may cause the electronic device to, based on identifying that the number of synchronization operations performed by the electronic device has not reached the set number of times, receive, from the second external electronic device via the communication circuitry, information related to a new BIG while performing the synchronization operation for the at least one BIS based on the stored information related to the According to one or more embodiments of the disclosure, the instructions, when executed by the one or processors individually or collectively, may cause the electronic device to, based on the information related to the new BIG, perform, via the communication circuitry, the synchronization operation for the at least one BIS.

According to one or more embodiments of the disclosure, the instructions, when executed by the one or processors individually or collectively, may cause the electronic device to, based on identifying that the number of synchronization operations performed by the electronic device has reached the set number of times, receive, from the external electronic device via the communication circuitry, information related to a new BIG.

According to one or more embodiments of the disclosure, the instructions, when executed by the one or processors individually or collectively, may cause the electronic device to, based on the information related to the new BIG, perform, via the communication circuitry, the synchronization operation for the at least one BIS.

According to one or more embodiments of the disclosure, the BIG asynchronous event may include at least one of an event in which synchronization with the at least one BIS is lost, or an event in which a request to stop receiving the audio data via the at least one BIS is identified.

According to one or more embodiments of the disclosure, the event in which the synchronization with the at least one BIS is lost may be detected if the audio data is not successfully received via the at least one BIS for set time.

According to one or more embodiments of the disclosure, the event in which the request to stop receiving the audio data via the at least one BIS is identified may be detected if information requesting to stop the synchronization with the at least one BIS is received.

According to one or more embodiments of the disclosure, the instructions, when executed by the one or processors individually or collectively, may cause the electronic device to, if the BIG asynchronous event is the event in which the request to stop receiving the audio data via the at least one BIS is identified, skip the synchronization operation for the at least one BIS based on the stored information related to the BIG until an event in which a request to resume receiving the audio data via the at least one BIS is identified is detected.

According to one or more embodiments of the disclosure, the information related to the BIG may be received via an auxiliary synchronization indication (AUX_SYNC_IND) protocol data unit (PDU).

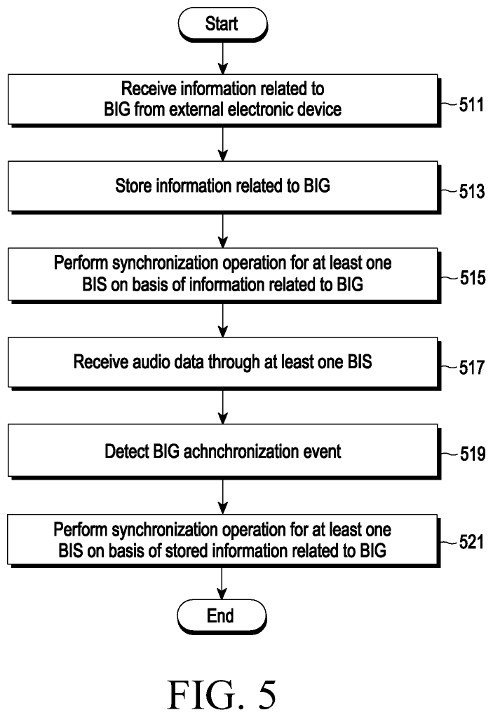

FIG. 5 is a flowchart schematically illustrating a method of operating an electronic device according to one or more embodiments.

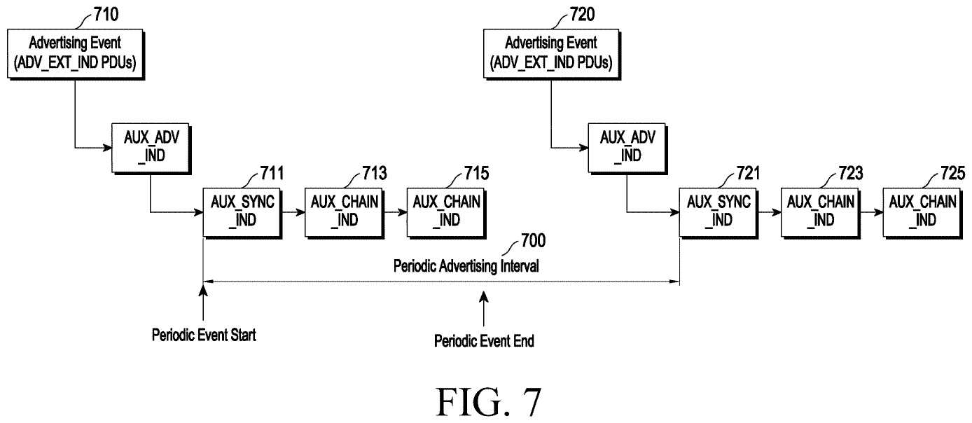

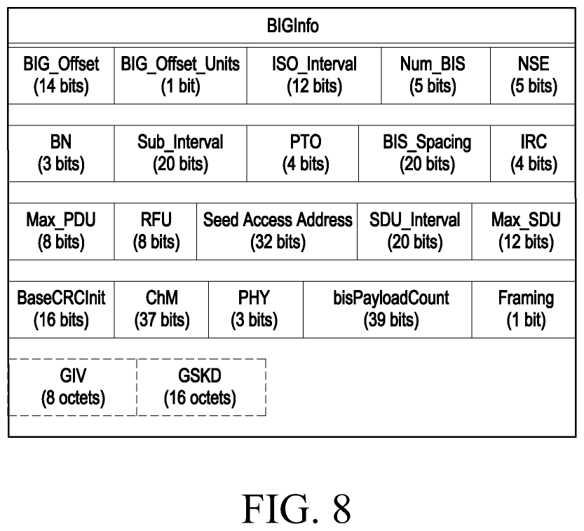

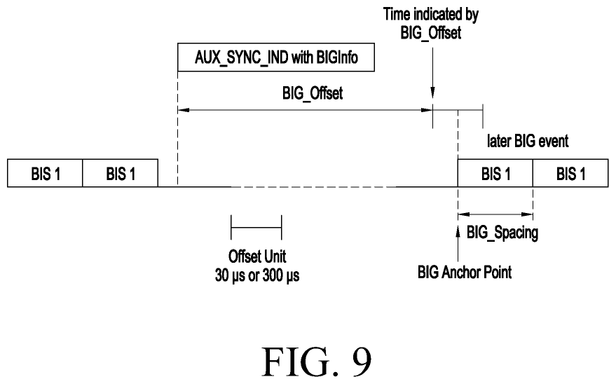

Referring to FIG. 5, an electronic device (e.g., an electronic device 101 in FIG. 1 or 2, or an electronic device 102 or an electronic device 104 in FIG. 1, or a first external electronic device 200 in FIG. 2 or 3) (e.g., a processor 120 in FIG. 1 or a processor 304 in FIG. 3) may, in operation 511, receive information related to a BIG from an external electronic device (e.g., a second external electronic device 210 in FIG. 2) via communication circuitry (e.g., a communication module 190 in FIG. 1 or communication circuitry 302 in FIG. 3). In one or more embodiments, the information related to the BIG may be received via a periodic advertising (PA) operation performed by an external electronic device which operates as a broadcast source device, and may include, for example, BIG information (BIGInfo). In one or more embodiments, the BIGInfo may be received via an auxiliary synchronization indication (AUX_SYNC_IND) protocol data unit (PDU). The periodic PA operation will be described below with reference to FIGS. 7 and 9, and the BIGInfo will be described below with reference to FIG. 8, so a detailed description thereof will be omitted herein.

The electronic device, which receives the information related to the BIG from the external electronic device, may store the information related to the BIG in memory (e.g., memory 130 in FIG. 1 or memory 306 in FIG. 3) in operation 513.

The electronic device, which stores the information related to the BIG, may, based on the information related to the BIG, perform a synchronization operation for at least one BIS provided by the external electronic device via communication circuitry in operation 515.

By performing the synchronization operation for the at least one BIS, the electronic device may be synchronized with the at least one BIS, and may receive audio data via the at least one BIS via the communication circuitry in operation 517.

While receiving the audio data via the at least one BIS, the electronic device may, in operation 519, detect a BIG asynchronous event related to asynchronous status for the BIG. In one or more embodiments, the BIG asynchronous event may include at least one of an event in which synchronization for the at least one BIS is lost, or an event in which a request to stop receiving the audio data via the at least one BIS is identified. In one or more embodiments, the event in which the synchronization for the at least one BIS is lost may be detected if the audio data is not successfully received via the at least one BIS for set time.

The electronic device, which detects the BIG asynchronous event, may, in operation 521, perform a synchronization operation for the at least one BIS based on stored information related to the BIG via the communication circuitry. As such, if the BIG asynchronous event is detected, the electronic device performs the synchronization operation for the at least one BIS based on the stored information related to the BIG without waiting until the information related to the BIG is received from the external electronic device, thereby reducing time for which an audio service is stopped due to the BIG asynchronous event.

In FIG. 5, a case that the synchronization operation is performed for the at least one BIS based on the stored information related to the BIG if the BIG asynchronous event is detected has been described as an example, however, if the BIG asynchronous event is the event in which the request to stop receiving the audio data via the at least one BIS is identified, even though the BIG asynchronous event is detected, after waiting until an event to resume receiving the audio data via the at least one BIS is detected, a synchronization operation for the at least one BIS may be performed based on the stored information related to the BIG after the event to resume receiving the audio data via the at least one BIS is detected.

Meanwhile, although FIG. 5 illustrates a method of operating an electronic device according to one or more embodiments, it should be noted that various modifications may be made to FIG. 5. For example, although FIG. 5 illustrates sequential operations, it should be noted that operations described in FIG. 5 may overlap, occur in parallel, occur in a different order, or occur multiple times.

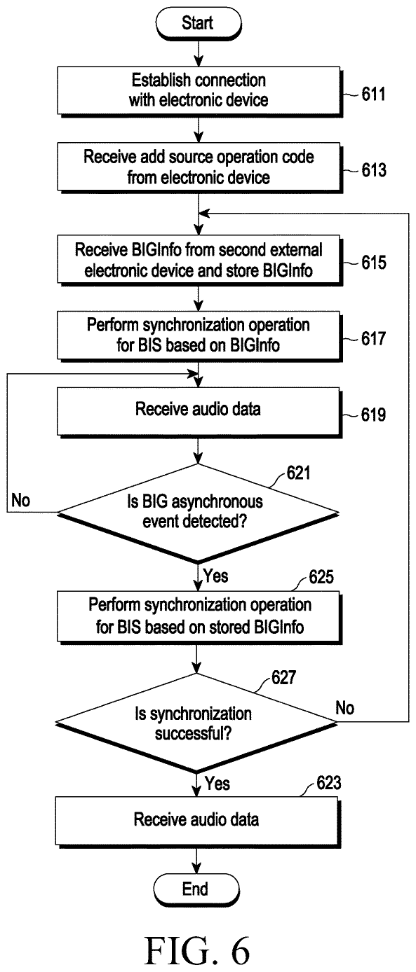

FIG. 6 is a flowchart schematically illustrating a method of operating a first external electronic device according to one or more embodiments.

Referring to FIG. 6, a first external electronic device (e.g., an electronic device 102 or an electronic device 104 in FIG. 1, or a first external electronic device 200 in FIG. 2 or 3) (e.g., a processor 304 in FIG. 3) may establish a connection (e.g., a communication link) with an electronic device (e.g., an electronic device 101 in FIG. 1 or 2) via communication circuitry (e.g., communication circuitry 302 in FIG. 3) in operation 611. In one or more embodiments, the first external electronic device may operate as a broadcast sink device. In one or more embodiments, the electronic device may operate as a broadcast assistant device. A broadcast source device, the broadcast assistant device, and the broadcast sink device may be implemented to be similar to or substantially the same as those described in FIG. 2 or 3, so a detailed description thereof will be omitted herein. In one or more embodiments, the first external electronic device may establish the connection with the electronic device based on at least one of a Wi-Fi scheme and/or a Bluetooth scheme. For example, the electronic device may be a smartphone. The first external electronic device may be an ear-wearable device and/or a speaker. The first external electronic device may include a first earbud (e.g., a left earbud) and/or a second earbud. The second external electronic device may be a TV or another smartphone.

In operation 611, an operation for the first external electronic device to establish the connection with the electronic device may be described more specifically as follows.

In one or more embodiments, the first external electronic device (e.g., the ear-wearable device and/or the speaker) may establish the connection with the electronic device (e.g., the smartphone) based on a wireless communication scheme (e.g., the BLE scheme). The first external electronic device may transmit the advertising signal to the surrounding in a multicast scheme or a broadcast scheme. The advertising signal may include information related to the connection or an account (e.g., pairing). For example, the advertising signal may include at least one of identification information of the first external electronic device, user account information associated with an account of a user of the first external electronic device, current pairing information which is information about whether the first external electronic device is currently paired with another device, a pairing list which is a list including information about devices with which the first external electronic device was previously paired, simultaneous pairing information which is information about devices with which the first external electronic device may be simultaneously paired, transmission power (TX power) of the first external electronic device, or battery status information which is information about a remaining battery level of the first external electronic device.

According to one or more embodiments, the first external electronic device may transmit (for example, broadcast or multicast) the advertising signal based on a set condition. For example, the set condition may include at least one of a condition in which power is supplied to the first external electronic device, a condition in which a set period is reached, or a condition in which a user input is identified.

If the electronic device receives the advertising signal transmitted by the first external electronic device, the electronic device may output a user interface (UI) for the connection between the first external electronic device and the electronic device on a display (e.g., a display module 160 in FIG. 1). In one or more embodiments, the electronic device may output the UI based on the information included in the advertising signal. For example, the UI may include an image corresponding to the first external electronic device. The electronic device may establish the connection (e.g., a first communication link) with the first external electronic device based on the information included in the received advertising signal.

If the first external electronic device is an ear-wearable device, the ear-wearable device may include a first earbud (e.g., a left earbud) and a second earbud (e.g., a right earbud). The first earbud and the second earbud may have address information about each other, and the first earbud and the second earbud may be stored in an earbuds-case device. If the earbuds-case device is opened while the first earbud and the second earbud are stored in the earbuds-case device, the first earbud and the second earbud may perform a page scan operation, and a connection (e.g., a second communication link) may be established between the first earbud and the second earbud based on the page scan operation. According to one or more embodiments, each of the first earbud and the second earbud may establish a connection with the electronic device.

The first external electronic device, which establishes the connection with the electronic device, may, in operation 613, receive, from the electronic device via the communication circuitry, an add source operation code which indicates an add source operation. The add source operation may be used for providing information about a broadcast source device to a broadcast audio scan service (BASS) server based on a generic attribute profile (GATT). The first external electronic device, which is a broadcast sink device, may operate as the BASS server, and the electronic device, which is a broadcast assistant device, may operate as a BASS client. The add source operation code may be included in broadcast audio scan control point characteristic operation codes, and the broadcast audio scan control point characteristic operation codes may be defined as shown in Tables 1-1 and 1-2 below.

TABLE 1-1

| | | | Section | |
|---|---|---|---|---|
| Opcode | Operation | Requirement | Reference | Description |
| 0x00 | Remote Scan | C.1 | Section | Informs the server that the client is not |
| | Stopped | | 3.1.1.2 | scanning for Broadcast Sources on behalf |
| | | | | of the server. |
| 0x01 | Remote Scan | C.1 | Section | Informs the server that the client is |
| | Started | | 3.1.1.3 | scanning for Broadcast Sources on behalf |
| | | | | of the server. |
| 0x02 | Add Source | C.1 | Section | Requests the server to add information |
| | | | 3.1.1.4 | including Metadata for a Broadcast |
| | | | | Source, and requests the server to |
| | | | | synchronize to a PA and/or BIS |
| | | | | transmitted by the Broadcast Source. |
| 0x03 | Modify Source | C.1 | Section | Requests the server to update Metadata, to |
| | | | 3.1.1.5 | synchronize to, or to stop synchronizing |
| | | | | to a PA and/or BIS transmitted by the |
| | | | | Broadcast Source identified by the |
| | | | | Source_ID. |

TABLE 1-2

| | | | Section | |
|---|---|---|---|---|
| Opcode | Operation | Requirement | Reference | Description |
| 0x04 | Set | M | Section | Provides the server with the |
| | Broadcast_Code | | 3.1.1.6 | Broadcast_Code to decrypt a BIS |
| | | | | transmitted by a Broadcast Source |
| | | | | identified by the Source ID. |
| 0x05 | Remove Source | C.1 | Section | Requests the server to remove all |
| | | | 3.1.1.7 | information for a Broadcast Source |
| | | | | identified by the Source ID. |
| 0x06- | RFU | — | — | — |
| 0xFF | | | | |

A detailed description of the broadcast audio scan control point characteristic operation codes is specified in section 3.1 in Broadcast Audio Scan Service Revision v1.0 which is a specification provided by Generic Audio Working Group, so a redundant description will be omitted herein.

In one or more embodiments, the add source operation may have a format defined as in Table 2-1 and Table 2-2 below.

TABLE 2-1

| | Size | |
|---|---|---|
| Opcode | (Octets) | Description |
| 0x02 | 1 | 0x02 = Add Source operation |

TABLE 2-2

| | Size | |
|---|---|---|
| Parameter | (Octets) | Description |
| Advertiser_Address_Type | 1 | Advertiser_Address_Type for the Broadcast Source |
| | | 0x00 = Public Device Address or Public Identity Address |
| | | 0x01 = Random Device Address or Random (static) Identity |
| | | Address |
| | | All other values: RFU |
| Advertiser_Address | 6 | Advertiser_Address for the Broadcast Source |
| Advertising_SID | 1 | Advertising_SID_subfield of the ADI field of the |
| | | AUX_ADV_IND PDU or the LL_PERIODIC_SYNC_IND |
| | | containing the SyncInfo that points to the PA transmitted by the |
| | | Broadcast Source. |
| | | Range: 0x00-0x0F |
| | | All other values: RFU |
| Broadcast_ID | 3 | Broadcast_ID of the Broadcast Source |
| PA_Sync | 1 | 0x00: Do not synchronize to PA |
| | | 0x01: Synchronize to PA - PAST available |
| | | 0x02: Synchronize to PA - PAST not available |
| | | All other values: RFU |
| PA_Interval | 2 | SyncInfo field Interval parameter value |
| | | 0xFFFF: PA_Interval unknown |
| Num_Subgroups | 1 | Number of subgroups |
| BIS_Sync[i] | 4 | BIS_Sync parameter for the [i th] subgroup in the BIG 4-octet |
| | | bitfield. Bit 0-30 = BIS_index[1-31] |
| | | 0x00000000: 0b0 = Do not synchronize to BIS_index[x] |
| | | 0xxxxxxxxx: 0b1 = Synchronize to BIS_index[x] |
| | | 0xFFFFFFFF: No preference |
| | | Shall not exist if Num_Subgroups = 0 |
| Metadata_Length[i] | 1 | Length of the Metadata parameter value for the [i th] subgroup |
| | | in the BIG |
| | | Shall not exist if Num_Subgroups = 0 |
| Metadata[i] | Varies | LTV-formatted Metadata for the [i th] subgroup in the BIG |
| | | Shall exist only if the Metadata_Length parameter value is ≠ |
| | | 0x00 |

A detailed description of the add source operation is specified in section 3.1.1.4 Add Source operation in Broadcast Audio Scan Service Revision v1.0, so a redundant description will be omitted herein.

The first external electronic device, which receives the source add operation code from the electronic device, may identify information about the broadcast source device (e.g., a second external electronic device 210 in FIG. 2), and therefore, in operation 615, based on the information about the broadcast source device, receive BIG information (BIGInfo) from the broadcast source device via the communication circuitry and store the received BIGInfo in memory (e.g., memory 306 in FIG. 3). In one or more embodiments, the first external electronic device may receive the BIGInfo via a periodic advertising (PA) operation performed in the second external electronic device.

In one or more embodiments, the second external electronic device may perform the PA operation as illustrated in FIG. 7, and this may be described as follows.

FIG. 7 is a diagram for describing a PA operation performed by a second external electronic device according to one or more embodiments.

Referring to FIG. 7, a periodic advertising interval 700 may be an interval between two scheduled auxiliary synchronization indication (AUX_SYNC_IND) protocol data units (PDUs) 711, 721 from the same advertising set.

The AUX_SYNC_IND PDU may be a PDU used for synchronous advertising on a secondary advertising physical channel which does not expect a response, and the BIGInfo may be included in an additional controller advertising data (ACAD) field of the AUX_SYNC_IND PDU. The BIGInfo will be described in detail with reference to Table 9 below, so a detailed description will be omitted herein.

A format of the AUX_SYNC_IND PDU may be as shown in Table 3 below.

TABLE 3

| | | Common Extended Advertising Payload Format fields | | | | | | | | |
|---|---|---|---|---|---|---|---|---|---|---|
| Adv | | | | CTE | | Aux | Sync | Tx | | Adv |
| Mode | Event Type | AdvA | TargetA | Info | ADI | Ptr | Info | Power | ACAD | Data |
| 0b00 | Non- | X | X | ◯ | ◯ | ◯ | X | ◯ | ◯ | ◯ |
| | Connectable | | | | | | | | | |
| | and Non- | | | | | | | | | |
| | Scannable | | | | | | | | | |
| | Undirected | | | | | | | | | |
| | or | | | | | | | | | |
| | Directed | | | | | | | | | |
| 0b01 | RFU | | | | | | | | | |
| to | | | | | | | | | | |
| 0b11 | | | | | | | | | | |

A detailed description of the AUX_SYNC_IND PDU is specified in section 2.3.1.7 of Bluetooth Core Specification v5.4 provided by Core Specification Working Group, so a redundant description will be omitted herein.

The periodic advertising interval may be an integer multiple of 1.25 ms, for example, in a range of 7.5 ms to 81.91875 s. A periodic advertising event may consist of the AUX_SYNC_IND PDU and a subordinate set of the AUX_SYNC_IND PDU. For example, a first periodic advertising event 710 may include an AUX_SYNC_IND PDU 711, an AUX_CHAIN_IND PDU 713, and an AUX_CHAIN_IND PDU 715, and a second periodic advertising event 720 may include an AUX_SYNC_IND PDU 721, an AUX_CHAIN_IND PDU 723, and an AUX_CHAIN_IND PDU 725. An auxiliary chain indication (AUX_CHAIN_IND) PDU may be used for maintaining additional advertising data (AdvData).

Two periodic advertising events for the same periodic advertising train may not overlap each other. The periodic advertising interval may not be changed while the periodic advertising is activated.

An ADV_EXT_IND PDU may be transmitted at every set advertising interval, and the ADV_EXT_IND PDU may include an auxiliary packet point indicating a location of the AUX_ADV_IND PDU and channel information. The AUX_ADV_IND PDU may include an access address and a channel map of an AUX_SYNC_IND PDU, which may include the BIGInfo, an advertising interval, a clock accuracy, and/or a time offset from the AUX_ADV_IND PDU. The AUX_SYNC_IND PDU may start to be transmitted before audio data is actually transmitted via a BIS, and if the audio data is transmitted via the BIS, may include a BIS parameter and the BIGInfo including information related to transmission of the audio data transmitted via the BIS.

Referring back to FIG. 6, the first external electronic device, which receives and stored the BIGInfo from the second external electronic device via the AUX_SYNC_IND PDU, may perform, in operation 617, a synchronization operation for at least one BIS provided by the second external electronic device based on the received BIGInfo. In one or more embodiments, the BIGInfo may be maintained until the second external electronic device terminates the BIG provided by the second external electronic device. For example, the BIGInfo may be changed if the second external electronic device terminates the BIG.

In one or more embodiments, the first external electronic device may perform the synchronization operation for the at least one BIS provided by the second external electronic device based on the BIGInfo, as illustrated in FIG. 8.

FIG. 8 is a diagram illustrating a format of BIGInfo.

Referring to FIG. 8, BIGInfo may be included in an ACAD field of the AUX_SYNC_IND PDU transmitted during a periodic advertising operation. A length of BIGInfo can be 33 octets for an unencrypted BIG and 57 octets for an encrypted BIG.

In one or more embodiments, a BIG_Offset field includes time from a start of a packet including BIGInfo to a BIG anchor point which BIGInfo describes. A value of the BIG_Offset field may be in a unit of time indicated by a BIG_Offset_Units bit, and an actual time offset may be determined by multiplying a value of BIG_Offset by the unit of time indicated by the BIG_Offset_Units bit. The offset may be greater than 600 μs.

In one or more embodiments, if the BIG_Offset_Units bit is set, the time unit indicated by the BIG_Offset_Units bit may be 300 μs, and if the BIG_Offset_Units bit is not set, the time unit indicated by the BIG_Offset_Units bit may be 30 μs. The BIG_Offset_Units bit may not be set if the time offset is less than 491,460 μs.

In one or more embodiments, as illustrated in FIG. 9, the BIG anchor point may not be earlier than the time offset and may not be later than the time offset plus one unit after a start of a relevant packet.

In one or more embodiments, an ISO_Interval field may indicate time between two adjacent BIG anchor points, and may be in a unit of 1.25 ms. A value of the ISO_Interval field may be a value between 4 and 3200 (i.e., 5 ms to 4 s).

In one or more embodiments, a NSE (number of subevent) field may indicate the number of subevents per BIS in each BIG event. A value of the NSE field may be a value between 1 and 31, and may be an integer multiple of BN.

In one or more embodiments, a BN field, a PTO field, and an IRC field may control which data is transmitted in each BIG event. A value of the BN field may be a value between 1 and 7, a value of the PTO field may be a value between 0 and 15, and a value of the IRC field may be a value between 1 and 15.

In one or more embodiments, a Sub_Interval field may indicate time between starts of two consecutive subevents of each BIS, and may be in microseconds.

In one or more embodiments, a BIS_Spacing field may indicate time between starts of corresponding subevents in adjacent BISes in the BIG, and may be in microseconds. Additionally, if a control subevent exists, the BIS_Spacing field may indicate time between a start of a first subevent of the last BIS and a start of the control subevent, and may be in microseconds.

In one or more embodiments, a Num_BIS field may indicate the number of BISes in the BIG.

In one or more embodiments, a Max_PDU field may indicate the maximum number of data octets (including a message integrity check (MIC) if necessary) which may be carried in each BIS data PDU in the BIG. A value of the Max_PDU field may be a value between 1 and 251 octets.

In one or more embodiments, a SeedAccessAddress field may indicate a seed access address (SAA) for the BIG. An access address for a BIS may be derived from the SAA and may be a random number which satisfies the following condition.

$${SAA}_{19} = {SAA}_{15}$$

$${SAA}_{22} = {SAA}_{16} \neq {SAA}_{15}$$

$${SAA}_{25} = 0$$

$${SAA}_{23} = 1$$

For any pair of BIGs transmitted by the same device, SAA 15 to SSA 0 may differ in at least two bits.

In one or more embodiments, an SDU_Interval field may be a value between 0x0000FF and 0x0FFFFF, and may be in microseconds.

In one or more embodiments, a Max_SDU field may indicate a maximum size of a service data unit (SDU) in the BIG. A value of the Max_SDU field may be a value between 1 and 4095 octets.

In one or more embodiments, a BaseCRCInit field may indicate a BaseCRCInit value. For every broadcast isochronous PDU, a shift register included in a cyclic redundancy check (CRC) generator may be preset with the BaseCRCInit value from BIGInfo data in the most significant 2 octets and BIS_Number for a specific BIS in the least significant octet.

In one or more embodiments, a ChM field may include a channel map indicating a used data channel and unused data channels. Every channel is represented with a bit allocated according to a data channel index, and a least significant bit (LSB) may represent a data channel index 0 and a bit in a position 36 may represent a data channel index 36. A bit value of 0 may indicate that a channel is unused, and a bit value of 1 may indicate that the channel is used. Bits in a location 37, a location 38, and a location 39 may be reserved for future use.

In one or more embodiments, a PHY field may indicate a physical layer (PHY) used by the BIG, and a value of the PHY field may be specified as shown in Table 4 below.

TABLE 4

| Value | Meaning |
|---|---|
| 0 | LE 1M PHY |
| 1 | LE 2M PHY |
| 2 | LE Coded PHY |
| All other values | Reserved for future use |

In one or more embodiments, a bisPayloadCount field may be used for a first subevent of a BIG event indicated by the BIG_Offset field. For each BIG, payloads may be numbered in an order provided, starting from 0. This number may be used as a value of the bisPayloadCounter field for a PDU including a corresponding payload, for example, a field value of the bisPayloadCount field.

In one or more embodiments, a Framing field may be set if the BIG carries framed data.

In one or more embodiments, if the BIG is encrypted, a GIV field may be a 64-bit parameter, and the GSKD field may be a 128-bit parameter.

A detailed description of BIGInfo is specified in section 4.4.6.11 BIGInfo in Bluetooth Core Specification v5.4, so a redundant description thereof will be omitted herein.

FIG. 9 is a diagram for describing a time reference of a BIG event from a PA event.

Referring to FIG. 9, a first external electronic device (e.g., an electronic device 102 or an electronic device 104 in FIG. 1, or a first external electronic device 200 in FIG. 2 or 3) may receive information related to a BIS from a second external electronic device (e.g., a second external electronic device 210 in FIG. 2). For example, the first external electronic device may be an ear-wearable device and/or a speaker. The first external electronic device may include a first earbud (e.g., a left earbud) and/or a second earbud. The second external electronic device may be a TV or another smartphone. An electronic device (e.g., an electronic device 101 in FIG. 1 or 2) may be a smartphone.

For an audio service, a broadcast source device (e.g., the second external electronic device) may perform a PA operation so that at least one broadcast sink device (e.g., the first external electronic device) may receive audio data via at least one BIS, so the broadcast sink device may receive PA data transmitted (e.g., broadcasted) via the PA operation of the broadcast source device. For example, the first external electronic device may receive an ADV_EXT_IND PDU transmitted by the second external electronic device at every set advertising interval. The ADV_EXT_IND PDU may include an auxiliary packet point indicating a location of the AUX_ADV_IND PDU and channel information. The AUX_ADV_IND PDU may include an access address and a channel map of an AUX_SYNC_IND PDU, which may include the BIGInfo, an advertising interval, a clock accuracy, and/or a time offset from the AUX_ADV_IND PDU. The AUX_SYNC_IND PDU may start to be transmitted before audio data is actually transmitted via a BIS, and if the audio data is transmitted via the BIS, may include a BIS parameter and the BIGInfo including information related to transmission of the audio data transmitted via the BIS.

The electronic device, which operates as a broadcast assistant device, may perform a monitoring operation to receive an advertising signal transmitted from a neighbor device (e.g., the second external electronic device) and identify that the second external electronic device broadcasts the BIS. The advertising signal may include a BASS universal unique identifier (UUID) and a broadcast ID. The electronic device may output a list of a receivable broadcast service on a user interface (UI) based on the received advertising signal.

The electronic device may receive a PA signal periodically broadcasted by the second external electronic device based on synchronization information (SyncInfo) included in the advertising signal. The PA signal may include the BASS UUID and information related to the BIS. After receiving the PA signal, the electronic device may output the list of the receivable broadcast service on the UI.

The PA signal (e.g., the AUX_ADV_IND_PDU) may include the BIGInfo, and the first external electronic device may receive the audio data via the BIS based on the BIGInfo. The BIGInfo may be implemented to be similar to or substantially the same as that described in FIG. 8, so a detailed description thereof will be omitted herein.

As illustrated in FIG. 9, the first external electronic device may synchronize with at least one BIS broadcasted by the second external electronic device based on parameters such as BIG_Offset, Offset Unit, and BIS_Spacing included in the BIGInfo.

Referring back to FIG. 6, the first external electronic device, which performs the synchronization operation for the at least one BIS provided by the second external electronic device based on the received BIGInfo, may receive audio data via at least one synchronized BIS in operation 619. As such, while receiving the audio data via the at least one synchronized BIS, the first external electronic device may identify whether a BIG asynchronous event is detected in operation 621.

According to one or more embodiments, the BIG asynchronous event may include an event in which synchronization with a BIS is lost, or an event in which a request to stop receiving audio data via the BIS is identified.

In one or more embodiments, the event in which the synchronization with the BIS is lost may occur if a BIS PDU is not successfully received during set time. In one or more embodiments, the set time may be time corresponding to a BIG_Sync_Timeout parameter. The BIG_Sync_Timeout parameter may specify maximum permitted time between successful receptions of BIS PDUs. If the set time elapses, BIG synchronization may be lost. A value of the BIG_Sync_Timeout parameter may be set by the first external electronic device.

In one or more embodiments, the event in which the request to stop receiving audio the data via the BIS is identified may be detected if a modify source operation code indicating a modify source operation is received from the electronic device. The modify source operation may be used for providing metadata information about a broadcast source device to the BASS server. The modify source operation may be used for requesting the BASS server to add or update metadata for a broadcast source, and/or requesting, from the BASS server, synchronization with the PA and/or the BIS, or requesting the BASS server to stop the synchronization with the PA and/or the BIS. A detailed description of the modify source operation is specified in section 3.1.1.5 Modification Source Operation of Broadcast Audio Scan Service Revision v1.0, so a redundant description thereof will be omitted herein.

If the BIG asynchronous event is not detected (Operation 621—No), the first external electronic device may return to operation 619.

If the BIG asynchronous event is detected (Operation 621—Yes), the first external electronic device may, in operation 625, perform a synchronization operation for at least one BIS provided by the second external electronic device based on stored BIGInfo. In one or more embodiments, the BIGInfo may be maintained until the second external electronic device terminates a BIG provided by the second external electronic device, so the first external electronic device may perform the synchronization operation for the at least one BIS provided by the second external electronic device based on the stored BIGInfo.

The first external electronic device, which performs the synchronization operation for the at least one BIS provided by the second external electronic device based on the stored BIGInfo, may identify whether the synchronization for the at least one BIS is successful in operation 627. If the synchronization for the at least one BIS is successful (Operation 627—Yes), the first external electronic device may proceed to operation 623 and receive audio data via at least one synchronized BIS.

If the synchronization for the at least one BIS fails (Operation 627—No), the first external electronic device may identify that the second external electronic device no longer maintains the BIGInfo stored in the first external electronic device, or that an error exists in BIGInfo stored in the second external electronic device due to poor communication status such as deterioration of a channel quality (for example, if received signal strength is less than threshold received signal strength), and thus, may return to operation 615 to receive new BIGInfo from the second external electronic device and perform a synchronization operation for the at least one BIS provided by the second external electronic device. In one or more embodiments, the first external electronic device may synchronize with the PA of the second external electronic device to receive an AUX_SYNC_IND PDU from the second external electronic device, and obtain BIGInfo included in an ACAD field included in the AUX_SYNC_IND PDU. In FIG. 6, a case that the first external electronic device no longer performs the synchronization operation for the at least one BIS based on the stored BIGInfo if the synchronization for the at least one BIS fails has been described as an example, but the first external electronic device may attempt synchronization with the at least one BIS provided by the second external electronic device by performing the synchronization operation for the at least one BIS provided by the second external electronic device based on the stored BIGInfo until a number of times is reached that is set in consideration of various situations such as the channel status of the first external electronic device. For example, based on identifying that the number of synchronization operations performed by the first external electronic device does not reach the set number of times, the first external electronic device may perform the synchronization operation for the at least one BIS based on information related to the stored BIG. According to one or more embodiments, if the first external electronic device receives, from the second external electronic device, information (e.g., BIGInfo) related to a new BIG (for example, if receiving an AUX_SYNC_IND PDU including the BIGInfo) before the number of times the synchronization operation for the at least one BIS has been performed based on the stored information related to the BIG reaches the set number of times, the first external electronic device may perform the synchronization operation for the at least one BIS provided by the second external electronic device based on the BIGInfo received from the second external electronic device.

In FIG. 6, a case that the synchronization operation for the at least one BIS is performed based on the stored information related to the BIG if the BIG asynchronous event is detected has been described as an example, but if the BIG asynchronous event is the event in which the request to stop receiving the audio data via the at least one BIS is identified, even though the BIG asynchronous event is detected, the synchronization operation for the at least one BIS may be performed based on the stored information related to the BIG after the event to resume receiving the audio data via the at least one BIS is detected after waiting until the event to resume receiving the audio data via the at least one BIS is detected.

Meanwhile, a case has been described that upon detecting that the BIG asynchronous event is the event in which the request to stop receiving the audio data via the BIS is identified (for example, upon detecting that the source operation code indicating the modify source operation is received from the electronic device) in operation 621, the first external electronic device proceeds to operation 625 and performs the synchronization operation for the BIS based on the stored BIGInfo. However, upon detecting that the BIG asynchronous event is the event in which the request to stop receiving the audio data via the BIS is identified in operation 621, the first external electronic device may determine whether to perform the synchronization operation for the BIS based on the stored BIGInfo as necessary. For example, if the first external electronic device receives a signal requesting to perform the synchronization operation for the BIS based on the stored BIGInfo, the first external electronic device may perform the synchronization operation for the BIS based on the stored BIGInfo. Alternatively, upon detecting that the BIG asynchronous event is the event in which the request to stop receiving the audio data via the BIS is identified in operation 621, the first external electronic device may terminate without performing any further operation.

Meanwhile, although FIG. 6 illustrates a method of operating an electronic device according to one or more embodiments, it should be noted that various modifications may be made to FIG. 6. For example, although FIG. 6 illustrates sequential operations, it should be noted that operations described in FIG. 6 may overlap, occur in parallel, occur in a different order, or occur multiple times.

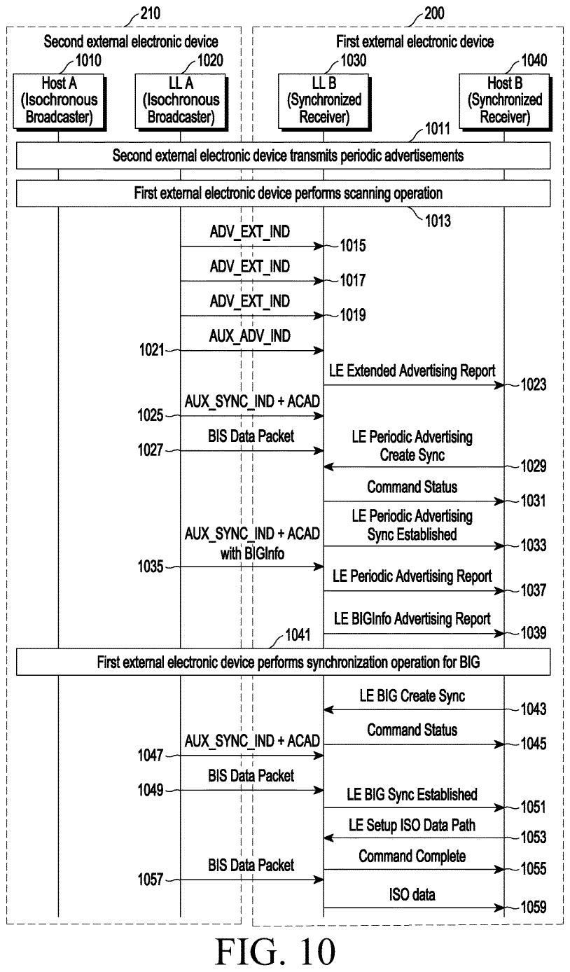

FIG. 10 is a signal flowchart illustrating an operation in which a first external electronic device synchronizes with a BIS of a second external electronic device according to one or more embodiments.

Referring to FIG. 10, a first external electronic device 200 (e.g., an electronic device 102 or an electronic device 104 in FIG. 1, or a first external electronic device 200 in FIG. 2 or 3) may operate as a broadcast sink device. A second external electronic device 210 (e.g., a second external electronic device 210 in FIG. 2) may operate as a broadcast source device. In this case, the second external electronic device 210 may operate as an isochronous broadcaster, and the first external electronic device 200 may operate as a synchronized receiver.

According to one or more embodiments, the second external electronic device 210 may include a host 1010 (e.g., host A) and a link layer (LL) 1020 (e.g., LL A). In one or more embodiments, the first external electronic device 200 may include a host 1040 (e.g., host B) and a link layer 1030 (e.g., LL B).

The second external electronic device 210 may transmit periodic advertisements in operation 1011. The first external electronic device 200 may perform a scanning operation in operation 1013.

The second external electronic device 210 may transmit an ADV_EXT_IND PDU in operations 1015, 1017, and 1019, and may transmit an AUX_ADV_IND PDU in operation 1021. In one or more embodiments, the ADV_EXT_IND PDU may include an auxiliary packet point indicating a location of the AUX_ADV_IND PDU and channel information. The AUX_ADV_IND PDU may include an access address of the AUX_SYNC_IND PDU, which may include BIGInfo, and channel map, an advertising interval, a clock accuracy, and/or a time offset from the AUX_ADV_IND PDU.

In operation 1023, LL B 1030 may transfer an LE Extended Advertising Report event to host B 1040 as the AUX_ADV_IND PDU is received. The LE Extended Advertising Report event may indicate that one or more Bluetooth devices have broadcast advertisements which have responded to an active scan or were received during a passive scan.

In operation 1025, LL A 1020 may transmit an AUX_SYNC_IND PDU including an ACAD field, and may transmit audio data (e.g., a BIS data packet) via a BIS in operation 1027. The AUX_SYNC_IND PDU may be implemented to be similar to or substantially the same as that described in FIG. 7 and Table 1, so a detailed description thereof will be omitted herein.

Host B 1040, which receives the LE Extended Advertising Report event from LL B 1030, may transfer, in operation 1029, an LE Periodic Advertising Create Sync command to LL B 1030 in response to the LE Extended Advertising Report event. In one or more embodiments, the LE Periodic Advertising Create Sync command may be used for starting receiving PA packets in synchronization with a PA train from an advertiser (e.g., the second external electronic device 210).

LL B 1030, which receives the LE Periodic Advertising Create Sync command from host B 1040, may transfer a Command Status event to host B 1040 in operation 1031. In one or more embodiments, the Command Status event may be used for indicating that a command described by a Command_Opcode parameter has been received and that a controller (e.g., LL B 1030) is performing a task corresponding to the received command.

LL B 1030, which transfers the Command Status event to host B 1040, may transfer an LE Periodic Advertising Sync Established event to host B 1040 in operation 1033. In one or more embodiments, the LE Periodic Advertising Sync Established event may be used for indicating that LL B 1030 has received a first PA packet from the second external electronic device 210 after a Periodic Advertising Create Sync command is transmitted.

Thereafter, in operation 1035, LL A 1020 may transmit an AUX_SYNC_IND PDU including an ACAD field including BIGInfo (AUX_SYNC_IND+ACAD with BIGInfo). LL B 1030, which receives the AUX_SYNC_IND PDU, may transfer an LE Periodic Advertising Report event to host B 1040 in operations 1037 and 1039. In one or more embodiments, the LE Periodic Advertising Report event may be used for indicating that LL B 1030 has received a periodic advertisement or has failed to receive an AUX_SYNC_SUBEVENT_IND PDU.

After the first external electronic device 200 is synchronized with the PA of the second external electronic device 210, the first external electronic device 200 may perform a synchronization operation for a BIG provided by the second external electronic device 210 in operation 1041. In operation 1043, host B 1040 may transfer an LE BIG Create Sync command to LL B 1030 for synchronization with the BIS provided by the second external electronic device 210. In one or more embodiments, the LE BIG Create Sync command may be expressed as in Table 5 below. In one or more embodiments, the LE BIG Create Sync command may be used for synchronization with a BIG described in the PA train.

TABLE 5

| Command | OCF | Command Parameters | Return Parameters |
|---|---|---|---|
| HCI_LE_BIG_Create_Sync | 0x006B | BIG_Handle, | none |
| | | Sync_Handle, | |
| | | Encryption, | |
| | | Broadcast_Code, | |
| | | MSE, | |
| | | BIG_Sync_Timeout, | |
| | | Num_BIS, | |
| | | BIS[i] | |

In Table 5, a BIG_Handle parameter may be allocated by LL B 1030 for identifying a synchronized BIG.

In Table 5, a Sync_Handle parameter may indicate an identifier of a PA train.

In Table 5, an Encryption parameter may be used for indicating whether a Broadcast_Code parameter is valid.

In Table 5, a Broadcast_Code parameter may be a 16-octet field used for generating a session key for encrypting or decrypting payloads of an encoded BIS.

In Table 5, a Maximum Subevents (MSE) parameter may indicate the maximum number of sub-events which LL B 1030 needs to use to receive data payloads at each interval for a BIS.

In Table 5, a BIG_Sync_Timeout parameter may indicate a maximum permitted time between successful receptions of BIS PDUs, and synchronization may be lost if time corresponding to the BIG_Sync_Timeout parameter is exceeded. In one or more embodiments, after LL B 1030 is synchronized with the BIG, if a value of the BIG_Sync_Timeout parameter set by host B 1040 is less than 6×ISO_Interval, LL B 1030 may set the value of the BIG_Sync_Timeout parameter to 6×ISO_Interval.

In one or more embodiments, the BIG_Sync_Timeout parameter may be expressed as in Table 6 below.

TABLE 6
BIG_Sync_Timeout: Size: 2 octets

| Value | Parameter Description |
|---|---|
| N = 0xXXXX | Synchronization timeout for the BIG |
| | Range: 0x000A to 0x4000 |
| | Time = N × 10 ms |
| | Time Range: 100 ms to 163.84 s |

In Table 5, a Num_BIS parameter may indicate the number of BIS indices specified in BIS[i].

In Table 5, BIS[i] may indicate a list of indices corresponding to a BIS(es) in a synchronized BIG.

LL B 1030, which receives the LE BIG Create Sync command from host B 1040, may transfer a Command Status event to host B 1040 in operation 1045.

Thereafter, in operation 1047, LL A 1020 may transmit an AUX_SYNC_IND PDU including an ACAD field (AUX_SYNC_IND_PDU+ACAD). The AUX_SYNC_IND PDU may include the ACAD field including BIGInfo or the ACAD field not including the BIGInfo. For example, LL A 1020 transmits the AUX_SYNC_IND PDU including the ACAD field including the BIGInfo in operation 1035, but LL A 1020 may transmit an AUX_SYNC_IND PDU including the ACAD field not including the BIGInfo in operation 1047.

In operation 1049, LL A 1020 may transmit a BIS data packet. In operation 1051, LL B 1030 may receive the BIS data packet transmitted from the second external electronic device 210 and may transfer an LE BIG Sync Established event to host B 1040. In one or more embodiments, the LE BIG Sync Established event may be used for indicating that the LE BIG Create Sync command has been completed.

Host B 1040, which receives the LE BIG Sync Established event, may transfer an LE Setup ISO Data Path command to LL B 1030 in operation 1053. In one or more embodiments, the LE Setup ISO Data Path command may be used for identifying and generating an isochronous data path between host B 1040 and LL B 1030 for the BIS.

LL B 1030, which receives the LE Setup ISO Data Path command from host B 1040, may transfer a Command Complete event to host B 1040 in operation 1055. In one or more embodiments, the Command Complete event may be used for LL B 1030 to transmit return status for a command.

LL A 1020 may transmit a BIS data packet in operation 1057. In operation 1059, LL B 1030 may receive the BIS data packet transmitted from the second external electronic device 210 and transmit ISO data to host B 1040 via a set up ISO data path.

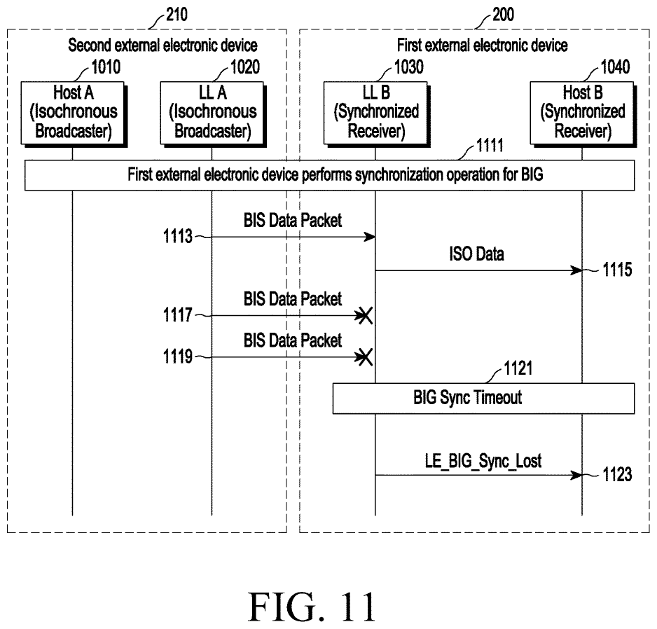

FIG. 11 is a diagram for describing an event in which synchronization for a BIS is lost.

Referring to FIG. 11, a first external electronic device 200 (e.g., an electronic device 102 or an electronic device 104 in FIG. 1, or a first external electronic device 200 in FIG. 2, 3, or 10) may operate as a broadcast sink device. A second external electronic device 210 (e.g., a second external electronic device 210 in FIG. 2 or 10) may operate as a broadcast source device. In this case, the second external electronic device 210 may operate as an isochronous broadcaster, and the first external electronic device 200 may operate as a synchronized receiver.

According to one or more embodiments, the second external electronic device 210 may include a host 1010 (e.g., host A) and a link layer 1020 (e.g., LL A). In one or more embodiments, the first external electronic device 200 may include a host 1040 (e.g., host B) and a link layer 1030 (e.g., LL B).

In operation 1111, the first external electronic device 200 may perform a synchronization operation for a BIG (or at least one BIS) provided by the second external electronic device 210, and thus may be synchronized with the BIG (or the at least one BIS) provided by the second external electronic device 210.

The LL A 1020 may transmit a BIS data packet in operation 1113. The LL B 1030 may receive the BIS data packet transmitted from the second external electronic device 210 and, in operation 1115, transmit ISO data to the Host B 1040 via a set up ISO data path.

Thereafter, even though the LL A 1020 continues to transmit a BIS data packet in operations 1117 and 1119, a case may occur that the LL B 1030 may not normally receive the BIS data packet transmitted from the second external electronic device 210. For example, if channel status between the first external electronic device 200 and the second external electronic device 210 is poor (for example, if the channel status between the first external electronic device 200 and the second external electronic device 210 is less than a threshold quality), even though the second external electronic device 210 transmits the BIS data packet, the first external electronic device 200 may not receive the BIS data packet transmitted by the second external electronic device 210.

As such, if the LL B 1030 is not capable of normally receiving the BIS data packet transmitted from the second external electronic device 210, time corresponding to a BIG_Sync_Timeout parameter may elapse in operation 1121. As the time corresponding to the BIG_Sync_Timeout parameter elapses, the LL B 1030 may detect an event in which synchronization with a BIS is lost. As the time corresponding to the BIG_Sync_Timeout parameter elapses, the LL B 1030 may transfer a LE_BIG_Sync_Lost event to the Host B 1040 in operation 1123. In one or more embodiments, the LE_BIG_Sync_Lost event may be used for indicating that synchronization with a synchronized BIG is lost.

As such, if the LE_BIG_Sync_Lost event occurs, the first external electronic device 200 may change BIS_Sync_Index of a broadcast receive state characteristic to 0x0 (Not synchronized to BIS_Index[x]) and transmit the changed broadcast receive state characteristic to an electronic device (e.g., an electronic device 101 in FIG. 1 or 2).

A detailed description of the broadcast receive state characteristic is specified in Broadcast Audio Scan Service Revision v1.0 which is a standard provided by Generic Audio Working Group, and this may be described as follows.

The broadcast receive state characteristic may be used by a BASS server to expose information about the broadcast source device (e.g., the second external electronic device 210 in FIG. 2 or 10). The information about the broadcast source device may indicate current synchronization status of the BASS server to PA and/or a BIG, which includes one or more subgroups including one or more BISes transmitted by the broadcast source device. The broadcast receive state characteristic may be used for informing BASS clients whether the BASS server has detected that a BIS has been encrypted, whether the BASS server requires a broadcast code (Broadcast_Code), and whether the BASS server is decrypting the BIS. When the broadcast receive state characteristic is not empty (length 0), the broadcast receive state characteristic may have a format defined as shown in Tables 7-1 and 7-2 below.

TABLE 7-1

| | Size | |
|---|---|---|
| Field | (Octets) | Description |
| Source_ID | 1 | Assigned by the server |
| | | Shall be unique for each instance of the Broadcast Receive State |
| | | characteristic exposed by the server |
| | | Range: 0x00-0xFF |
| Source_Address_Type | 1 | 0x00 = Public Device Address or Public Identity Address |
| | | 0x01 = Random Device Address or Random (static) Identity |
| | | Address |
| | | All other values: RFU |
| Source_Address | 6 | Public Device Address, Random Device Address, Public Identity |
| | | Address or Random (static) Identity Address of the Broadcast |
| | | Source. |
| Source_Adv_SID | 1 | Advertising_SID subfield of the ADI field of the AUX_ADV_IND |
| | | PDU or the LL_PERIODIC_SYNC_IND containing the SyncInfo |
| | | that points to the PA transmitted by the Broadcast Source. |
| Broadcast_ID | 3 | Broadcast_ID of the Broadcast Source |
| PA_Sync_State | 1 | 0x00: Not synchronized to PA |
| | | 0x01: SyncInfo Request |
| | | 0x02: Synchronized to PA |
| | | 0x03: Failed to synchronize to PA |
| | | 0x04: No PAST |
| | | All other values: RFU |
| BIG_Encryption | 1 | 0x00: Not encrypted |
| | | 0x01: Broadcast_Code required |
| | | 0x02: Decrypting |
| | | 0x03: Bad_Code (incorrect encryption key) |
| | | All other values: RFU |
| Bad_Code | Varies | If BIG_Encryption field value = 0x00, 0x01, or 0x02: empty (zero |
| | | length) |
| | | If BIG_Encryption field value = 0x03 (Bad_Code), Bad_Code |
| | | shall be set to the value of the incorrect 16-octet |
| | | Broadcast_Code that fails to decrypt the BIG |
| Num_Subgroups | 1 | Number of subgroups |
| BIS_Sync State[i] | 4 | BIS_Sync_State for the [i th] subgroup |

TABLE 7-2

| | Size | |
|---|---|---|
| Field | (Octets) | Description |
| | | 4-octet bitfield. Bit 0-30 = BIS_index[1-31] |
| | | 0x00000000: 0b0 = Not synchronized to BIS_index[x] |
| | | 0xxxxxxxxx: 0b1 = Synchronized to BIS_index[x] |
| | | 0xFFFFFFFF: Failed to sync to BIG |
| | | Shall not exist if Num_Subgroups = 0 |
| Metadata_Length[i] | 1 | Length of the Metadata field for the [i th] subgroup |
| | | Shall not exist if Num Subgroups = 0 |
| Metadata[i] | Varies | LTV-formatted Metadata for the [i th] subgroup |
| | | Shall exist only if the Metadata Length parameter value is ≠ 0x00 |

In Table 7-1, the Source_ID field may indicate a Source_ID, the Source_ID may be assigned by the BASS server and may be unique for each instance of a broadcast receive state characteristic exposed by a BASS. For example, a size of the Source_ID field may be implemented with 1 octet, and its range may be 0x00-0xFF.

In Table 7-1, the Source_Address_Type field may indicate Source_Address_Type, and if a field value of the Source_Address_Type field is 0x00, it may indicate a public device address or a public identity address (0x00=Public Device Address or Public Identity Address). If the field value of the Source_Address_Type field is 0x01, it may indicate a random device address or a random (static) identity address (0x01=Random Device Address or Random (static) Identity Address). For example, a size of the Source_Address_Type field may be implemented with 1 octet. The remaining field values of the Source_Address_Type field may be reserved for future use (All other values: RFU).

In Table 7-1, the Source_Address field may indicate a public device address, a random device address, a public identity address, or a random (static) identity address of the broadcast source device. For example, a size of the Source_Address field may be 6 octets.

In Table 7-1, the Source_Adv_SID field may be an Advertising_SID subfield of an AdvDataInfo (ADI) field of an AUX_ADV_IND protocol data unit (PDU) or an LL_PERIODIC_SYNC_IND PDU including synchronization information (SyncInfo) that points to periodic advertising (PA) transmitted by the broadcast source device. For example, a size of the Source_Adv_SID field may be 1 octet

In Table 7-1, the Broadcast_ID field may indicate a broadcast ID (Broadcast_ID) of the broadcast source device. For example, a size of the Broadcast_ID field may be 3 octets

In Table 7-1, if a field value of the PA_Sync_State field is “0x00”, it may indicate that it is not synchronized to a PA (0x00: Not synchronized to PA), if the field value of the PA_Sync_State field is “0x01”, it may indicate a synchronization information request (0x01: SyncInfo Request), if the field value of the PA_Sync_State field is “0x02”, it may indicate that it is synchronized to the PA (0x02: Synchronized to PA), if the field value of the PA_Sync_State field is “0x03”, it may indicate that synchronization to the PA has failed (0x03: Failed to synchronize to PA), and if the field value of the PA_Sync_State field is “0x04”, it may indicate that a periodic advertising synchronization transfer (PAST) procedure does not exist (0x04: No PAST). For example, a size of the PA_Sync_State field may be 1 octet. The remaining field values of the PA_Sync_State field may be reserved for future use (All other values: RFU).

In Table 7-1, if a field value of the BIG_Encryption field is “0x00”, it may indicate that it is not encrypted (0x00: Not encrypted), if the field value of the BIG_Encryption field is “0x01”, it may indicate that a broadcast code is required (0x01: Broadcast_Code required), if the field value of the BIG_Encryption field is “0x02”, it may indicate that it is decrypting (0x02: Decrypting), and if the field value of the BIG_Encryption field is “0x03”, it may indicate a bad code (0x03: Bad_Code (incorrect encryption key)). The bad code may indicate an incorrect encryption key. For example, a size of the BIG_Encryption field may be 1 octet. The remaining field values of the BIG_Encryption field may be reserved for future use (All other values: RFU).

In Table 7-1, if a field value of the BIG_Encryption field is 0x00, 0x01, or 0x02, the Bad_Code field may be empty. A fact that the Bad_Code field is empty may indicate that a length of the Bad_Code field is zero (0). (If BIG_Encryption field value=0x00, 0x01, or 0x02: empty (zero length)). If the field value of the BIG_Encryption field is 0x03 (Bad_Code), the field value of the Bad_Code field may be set to a value of an incorrect 16-octet broadcast code that fails to decrypt a BIG (If BIG_Encryption field value=0x03 (Bad_Code), Bad_Code shall be set to the value of the incorrect 16-octet Broadcast_Code that fails to decrypt the BIG). For example, a size of the BIG_Encryption field may be variable.

In Table 7-1, the Num_Subgroups field may indicate the number of subgroups. For example, a size of the Num_Subgroups field may be 1 octet.

In Table 7-1, the BIS_Sync State[i] field may indicate BIS synchronization state (BIS_Sync_State) for the i-th subgroup. Bits 0-30 of the BIS_Sync State[i] field may indicate BIS index (BIS_index) 1 to BIS index 31 (Bits 0-30=BIS_index[1-31]), and if the field value of the BIS_Sync State[i] field is 0x00000000: 0b0, it may indicate that it is not synchronized to the BIS index x (BIS_index[x]) (0x00000000: 0b0=Not synchronized to BIS_index[x]), if the field value of the BIS_Sync State[i] field is 0xxxxxxxxx: 0b1, it may indicate that it is synchronized to the BIS index x (0xxxxxxxxx: 0b1=Synchronized to BIS_index[x]), if the field value of the BIS_Sync_State[i] field is 0xFFFFFFFF, it may indicate that synchronization to the BIG has failed (0xFFFFFFFF: Failed to sync to BIG), and if the value of the Num_Subgroups field is set to 0, the BIS_Sync_State[i] field will not exist (Shall not exist if Num_Subgroups=0). For example, a size of the BIS_Sync_State[i] field may be 4 octets.

The BIS_Sync_State[i] field may be used to expose a synchronization state of the BASS server with respect to one or more BISs for one or more subgroups included in a BIG (The BIS_Sync_State field is used to expose the synchronization state of the server with respect to one or more BISes for one or more subgroups in a BIG).

As in operation 1121, if a BIG asynchronous event is detected, the first external electronic device 200 may perform a synchronization operation for the BIG (or the at least one BIS) provided by the second external electronic device 210 based on the BIGInfo received and stored from the second external electronic device 210. If the synchronization for the BIG (or the at least one BIS) provided by the second external electronic device 210 is successful, the first external electronic device 200 may change the BIS_Sync_Index of the Broadcast Receive State Characteristic to 0xxxxxxxxx (Synchronized to BIS_Index[x]) and transmit the changed Broadcast Receive State Characteristic to the electronic device.

Previously, the first external electronic device 200 could perform a synchronization operation for the BIG (or the at least one BIS) provided by the second external electronic device 210 based on BIGInfo included in an AUX_SYNC_IND PDU only when receiving the AUX_SYNC_IND PDU including the BIGInfo from the second external electronic device 210, and therefore, if the AUX_SYNC_IND PDU was not received, or if the AUX_SYNC_IND PDU was received but the received AUX_SYNC_IND PDU did not include the BIGInfo, the synchronization operation for the BIG (or the at least one BIS) provided by the second external electronic device 210 could not be performed. So, if the BIG asynchronous event is detected, a case may occur that an audio service is stopped until the AUX_SYNC_IND PDU including the BIGInfo is received.

In the disclosure, if a BIG asynchronous event is detected, without waiting until an AUX_SYNC_IND PDU including BIGInfo is received, a synchronization operation for a BIG (or at least one BIS) provided by the second external electronic device 210 is performed based on BIGInfo stored during an initial synchronization operation for the BIG (or the at least one BIS) provided by the second external electronic device 210, thereby reducing (for example, minimizing) time for which the audio service is stopped.

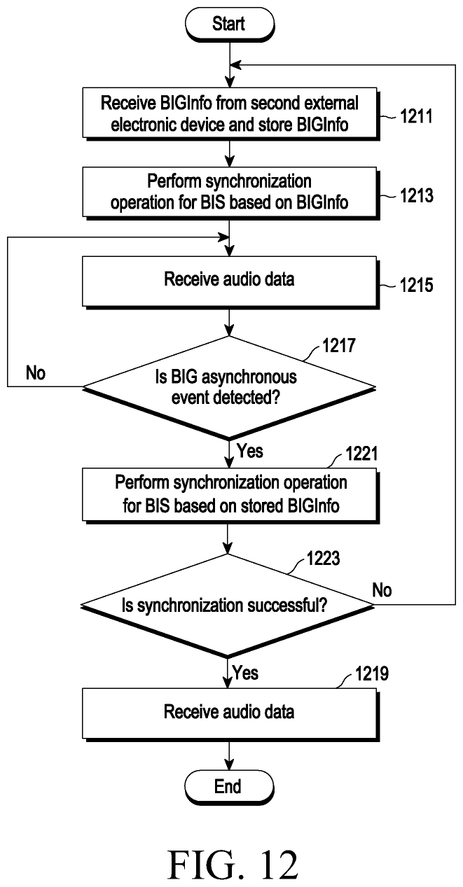

FIG. 12 is a flowchart schematically illustrating a method of operating an electronic device according to one or more embodiments.

Referring to FIG. 12, an electronic device (e.g., an electronic device 101 in FIG. 1 or 2) (e.g., a processor 120 in FIG. 1) may, in operation 1211, receive BIGInfo transmitted (e.g., broadcast) from a broadcast source device (e.g., a second external electronic device 210 in FIG. 2, 10, or 11) via communication circuitry, and store the received BIGInfo in memory (e.g., memory 130 in FIG. 1). In one or more embodiments, the electronic device may receive the BIGInfo via a PA operation performed by the second external electronic device. In one or more embodiments, the electronic device may receive the BIGInfo from the second external electronic device via an AUX_SYNC_IND PDU.

The first external electronic device, which receives and stores the BIGInfo from the second external electronic device via the AUX_SYNC_IND PDU, may, in operation 1213, perform a synchronization operation for at least one BIS provided by the second external electronic device based on the received BIGInfo. Subsequent operations 1213 to 1223 may be implemented to be similar to or substantially the same as operations 615 to 627 described in FIG. 6, so a detailed description thereof will be omitted herein. However, since an operation is performed by the first external electronic device in FIG. 6, an event in which a request to stop receiving audio data via a BIS is identified may be detected if a modify source operation code indicating a modify source operation is received from the electronic device, whereas, since an operation is performed by the electronic device in FIG. 12, the event in which the request to stop receiving the audio data via the BIS is identified may be detected if a user input for stopping receiving the audio data via the BIS is identified.

According to one or more embodiments of the disclosure, a method of an electronic device (101; 200) may comprise receiving information related to a BIG from an external electronic device (210) via the communication circuitry.

According to one or more embodiments of the disclosure, the method may comprise storing the information related to the BIG.

According to one or more embodiments of the disclosure, the method may comprise, based on the information related to the BIG, performing a synchronization operation for at least one BIS provided by the external electronic device.

According to one or more embodiments of the disclosure, the method may comprise receiving audio data via the at least one BIS.

According to one or more embodiments of the disclosure, the method may comprise, while receiving the audio data, detecting a BIG asynchronous event related to an asynchronous state for the BIG.

According to one or more embodiments of the disclosure, the method may comprise, based on the BIG asynchronous event, performing the synchronization operation for the at least one BIS based on the stored information related to the BIG.

According to one or more embodiments of the disclosure, the method may comprise identifying whether synchronization with the at least one BIS is successful according to the synchronization operation for the at least one BIS which is based on the stored information related to the BIG.

According to one or more embodiments of the disclosure, the method may comprise, based on identifying that the synchronization to the at least one BIS is successful, receiving audio data via the at least one BIS.

According to one or more embodiments of the disclosure, the method may comprise, based on identifying that the synchronization with the at least one BIS has failed, receiving information related to a new BIG from the external electronic device.

According to one or more embodiments of the disclosure, the method may comprise, based on the information related to the new BIG, performing the synchronization operation for the at least one BIS.

According to one or more embodiments of the disclosure, the method may comprise, based on identifying that the synchronization with the at least one BIS has failed, identifying whether a number of synchronization operations performed by the electronic device reaches a set number of times for the synchronization operation for the at least one BIS.

According to one or more embodiments of the disclosure, the method may comprise, based on identifying that it has not reached the set number of times, performing the synchronization operation for the at least one BIS based on the stored information related to the BIG.

According to one or more embodiments of the disclosure, the method may comprise, based on identifying that the number of synchronization operations performed by the electronic device has not reached the set number of times, receiving, from the external electronic device, information related to a new BIG while performing the synchronization operation for the at least one BIS based on the stored information related to the BIG.

According to one or more embodiments of the disclosure, the method may comprise, based on the information related to the new BIG, performing the synchronization operation for the at least one BIS.

According to one or more embodiments of the disclosure, the method may comprise, based on identifying that the number of synchronization operations performed by the electronic device has reached the set number of times, receiving, from the external electronic device, information related to a new BIG.

According to one or more embodiments of the disclosure, the method may comprise, based on the information related to the new BIG, performing the synchronization operation for the at least one BIS.

According to one or more embodiments of the disclosure, the BIG asynchronous event may include at least one of an event in which synchronization with the at least one BIS is lost, or an event in which a request to stop receiving the audio data via the at least one BIS is identified.

According to one or more embodiments of the disclosure, the event in which the synchronization with the at least one BIS is lost may be detected if the audio data is not successfully received via the at least one BIS for set time.

According to one or more embodiments of the disclosure, a method of an electronic device (200) may comprise establishing a connection with a first external electronic device (101).

According to one or more embodiments of the disclosure, the method may comprise receiving information about a second external electronic device (210) from the first external electronic device.

According to one or more embodiments of the disclosure, the method may comprise, based on the information about the second external electronic device, receiving information related to a BIG from the second external electronic device.

According to one or more embodiments of the disclosure, the method may comprise storing the information related to the BIG.

According to one or more embodiments of the disclosure, the method may comprise, based on the information related to the BIG, performing a synchronization operation for at least one BIS provided by the second external electronic device.

According to one or more embodiments of the disclosure, the method may comprise receiving audio data via the at least one BIS.

According to one or more embodiments of the disclosure, the method may comprise, while receiving the audio data, detecting a BIG asynchronous event related to an asynchronous state for the BIG.

According to one or more embodiments of the disclosure, the method may comprise, based on the BIG asynchronous event, performing the synchronization operation for the at least one BIS based on the stored information related to the BIG.

According to one or more embodiments of the disclosure, the method may comprise identifying whether synchronization with the at least one BIS is successful according to the synchronization operation for the at least one BIS which is based on the stored information related to the BIG.

According to one or more embodiments of the disclosure, the method may comprise, based on identifying that the synchronization to the at least one BIS is successful, receiving audio data via the at least one BIS.

According to one or more embodiments of the disclosure, the method may comprise, based on identifying that the synchronization with the at least one BIS has failed, receiving information related to a new BIG from the second external electronic device.

According to one or more embodiments of the disclosure, the method may comprise, based on the information related to the new BIG, performing the synchronization operation for the at least one BIS.

According to one or more embodiments of the disclosure, the method may comprise, based on identifying that the synchronization with the at least one BIS has failed, identifying whether a number of synchronization operations performed by the electronic device reaches a set number of times for the synchronization operation for the at least one BIS.

According to one or more embodiments of the disclosure, the method may comprise, based on identifying that it has not reached the set number of times, performing the synchronization operation for the at least one BIS based on the stored information related to the BIG.

According to one or more embodiments of the disclosure, the method may comprise, based on identifying that the number of synchronization operations performed by the electronic device has not reached the set number of times, receiving, from the second external electronic device, information related to a new BIG while performing the synchronization operation for the at least one BIS based on the stored information related to the BIG.

According to one or more embodiments of the disclosure, the method may comprise, based on the information related to the new BIG, performing the synchronization operation for the at least one BIS.

According to one or more embodiments of the disclosure, the method may comprise, based on identifying that the number of synchronization operations performed by the electronic device has reached the set number of times, receiving, from the external electronic device, information related to a new BIG.

According to one or more embodiments of the disclosure, the method may comprise, based on the information related to the new BIG, performing the synchronization operation for the at least one BIS.

According to one or more embodiments of the disclosure, the BIG asynchronous event may include at least one of an event in which synchronization with the at least one BIS is lost, or an event in which a request to stop receiving the audio data via the at least one BIS is identified.

According to one or more embodiments of the disclosure, the event in which the synchronization with the at least one BIS is lost may be detected if the audio data is not successfully received via the at least one BIS for set time.

According to one or more embodiments of the disclosure, the event in which the request to stop receiving the audio data via the at least one BIS is identified may be detected if information requesting to stop the synchronization with the at least one BIS is received.

According to one or more embodiments of the disclosure, the method may comprise, if the BIG asynchronous event is the event in which the request to stop receiving the audio data via the at least one BIS is identified, skipping the synchronization operation for the at least one BIS based on the stored information related to the BIG until an event in which a request to resume receiving the audio data via the at least one BIS is identified is detected.

According to one or more embodiments of the disclosure, the information related to the BIG may be received via an AUX_SYNC_IND PDU.

According to one or more embodiments of the disclosure, a storage medium storing at least one instruction readable by a computer may be provided.

According to one or more embodiments of the disclosure, the at least one instruction, when executed by a processor (120; 304) including processing circuitry of an electronic device (101), may cause the electronic device to perform at least one operation

According to one or more embodiments of the disclosure, the at least one operation may comprise receiving information related to a BIG from an external electronic device (210).

According to one or more embodiments of the disclosure, the at least one operation may comprise storing the information related to the BIG.

According to one or more embodiments of the disclosure, the at least one operation may comprise, based on the information related to the BIG, performing a synchronization operation for at least one BIS broadcast by the external electronic device.

According to one or more embodiments of the disclosure, the at least one operation may comprise receiving audio data via the at least one BIS.

According to one or more embodiments of the disclosure, the at least one operation may comprise, while receiving the audio data, detecting a BIG asynchronous event related to an asynchronous state for the BIG.

According to one or more embodiments of the disclosure, the at least one operation may comprise, based on the BIG asynchronous event, performing the synchronization operation for the at least one BIS based on the stored information related to the BIG.

According to one or more embodiments of the disclosure, a storage medium storing at least one instruction readable by a computer may be provided.

According to one or more embodiments of the disclosure, the at least one instruction, when executed by a processor (304) including processing circuitry of an electronic device (200), may cause the electronic device to perform at least one operation.

According to one or more embodiments of the disclosure, the at least one operation may comprise establishing a connection with a first external electronic device (101).

According to one or more embodiments of the disclosure, the at least one operation may comprise receiving information about a second external electronic device (210) from the first external electronic device.

According to one or more embodiments of the disclosure, the at least one operation may comprise, based on the information about the second external electronic device, receiving information related to a BIG from the second external electronic device.

According to one or more embodiments of the disclosure, the at least one operation may comprise storing the information related to the BIG.

According to one or more embodiments of the disclosure, the at least one operation may comprise, based on the information related to the BIG, performing a synchronization operation for at least one BIS provided by the second external electronic device.

According to one or more embodiments of the disclosure, the at least one operation may comprise receiving audio data via the at least one BIS.

According to one or more embodiments of the disclosure, the at least one operation may comprise, while receiving the audio data, detecting a BIG asynchronous event related to an asynchronous state for the BIG.

According to one or more embodiments of the disclosure, the at least one operation may comprise, based on the BIG asynchronous event, performing the synchronization operation for the at least one BIS based on the stored information related to the BIG.

What is claimed is:

1. An electronic device, comprising:
communication circuitry;
one or more processors; and
memory storing instructions that, when executed by the one or processors individually or collectively, cause the electronic device to:
receive, via the communication circuitry, information corresponding to a broadcast isochronous group (BIG) from an external electronic device,
store, in the memory, the information corresponding to the BIG,
based on the information corresponding to the BIG, perform, via the communication circuitry, a first synchronization operation for at least one broadcast isochronous stream (BIS) broadcast by the external electronic device,
based on receiving audio data via the at least one BIS, detect a BIG asynchronous event corresponding to an asynchronous state for the BIG, and
based on the BIG asynchronous event, perform, via the communication circuitry, a second synchronization operation for the at least one BIS based on the stored information corresponding to the BIG.

2. The electronic device of claim 1, wherein the instructions, when executed by the one or more processors individually or collectively, cause the electronic device to:
based on a success of the second synchronization operation, receive the audio data via the at least one BIS.

3. The electronic device of claim 2, wherein the instructions, when executed by the one or more processors individually or collectively, cause the electronic device to:
based on a failure of the second synchronization operation, receive, via the communication circuitry, information corresponding to a second BIG from the external electronic device, and
based on the information corresponding to the second BIG, perform, via the communication circuitry, the first synchronization operation for the at least one BIS.

4. The electronic device of claim 2, wherein the instructions, when executed by the one or more processors individually or collectively, cause the electronic device to:
based on a failure of the second synchronization operation, identify a number of synchronization operations performed by the electronic device, and
based on identifying the number of synchronization operations performed is less than a set number of times for performing the second synchronization operation, perform, via the communication circuitry, the second synchronization operation for the at least one BIS based on the stored information related to the BIG.

5. The electronic device of claim 4, when executed by the one or more processors individually or collectively, cause the electronic device to:
based on identifying that the number of synchronization operations performed by the electronic device is less than the set number of times for performing the second synchronization operation, receive, from the external electronic device via the communication circuitry, information related to a second BIG while performing the second synchronization operation for the at least one BIS based on the stored information corresponding to the BIG, and
based on the information corresponding to the second BIG, perform, via the communication circuitry, the first synchronization operation for the at least one BIS.

6. The electronic device of claim 4, wherein the instructions, when executed by the one or more processors individually or collectively, cause the electronic device to:
based on identifying that the number of synchronization operations performed by the electronic device has reached the set number of times for performing the second synchronization operation, receive, from the external electronic device via the communication circuitry, information related to a second BIG, and
based on the information related to the second BIG, perform, via the communication circuitry, the first synchronization operation for the at least one BIS.

7. The electronic device of claim 1, wherein the BIG asynchronous event comprises at least one of an event in which synchronization with the at least one BIS is lost, or an event in which a request to stop receiving the audio data via the at least one BIS is identified.

8. The electronic device of claim 7, wherein the event in which the synchronization with the at least one BIS is lost is detected in response to the audio data is not being received via the at least one BIS for set time.

9. An electronic device, comprising:
communication circuitry;
one or more processors; and
memory storing instructions that, when executed by the one or processors individually or collectively, cause the electronic device to:
establish, via the communication circuitry, a connection with a first external electronic device,
receive, via the communication circuitry, information corresponding to a second external electronic device from the first external electronic device,
based on the information corresponding to the second external electronic device, receive, via the communication circuitry, information corresponding to a broadcast isochronous group (BIG) from the second external electronic device,
store the information corresponding to the BIG in the memory,
based on the information corresponding to the BIG, perform, via the communication circuitry, a first synchronization operation for at least one broadcast isochronous stream (BIS) broadcast by the second external electronic device,
based on receiving audio data via the at least one BIS, detect a BIG asynchronous event corresponding to an asynchronous state for the BIG, and
based on the BIG asynchronous event, perform, via the communication circuitry, a second synchronization operation for the at least one BIS based on the stored information corresponding to the BIG.

10. The electronic device of claim 9, wherein the instructions, when executed by the one or more processors individually or collectively, cause the electronic device to:
based on a success of the second synchronization operation, receive the audio data via the at least one BIS.

11. The electronic device of claim 10, wherein the instructions, when executed by the one or more processors individually or collectively, cause the electronic device to:
based on a failure of the second synchronization operation, receive, via the communication circuitry, information corresponding to a second BIG from the second external electronic device, and
based on the information corresponding to the second BIG, perform, via the communication circuitry, the first synchronization operation for the at least one BIS.

12. The electronic device of claim 10, wherein the instructions, when executed by the one or more processors individually or collectively, cause the electronic device to:
based on a failure of the second synchronization operation, identify a number of synchronization operations performed by the electronic device, and
based on identifying the number of synchronization operations performed is less than a set number of times for performing the second synchronization operation, perform, via the communication circuitry, the second synchronization operation for the at least one BIS based on the stored information corresponding to the BIG.

13. The electronic device of claim 12, when executed by the one or more processors individually or collectively, cause the electronic device to:
based on identifying that the number of synchronization operations performed by the electronic device is less than the set number of times for performing the second synchronization operation, receive, from the second external electronic device via the communication circuitry, information corresponding to a second BIG while performing the second synchronization operation for the at least one BIS based on the stored information corresponding to the BIG, and
based on the information corresponding to the second BIG, perform, via the communication circuitry, the first synchronization operation for the at least one BIS.

14. The electronic device of claim 12, wherein the instructions, when executed by the one or more processors individually or collectively, cause the electronic device to:
based on identifying that the number of synchronization operations performed by the electronic device has reached the set number of times for performing the second synchronization operation, receive, from the second external electronic device via the communication circuitry, information related to a second BIG, and
based on the information related to the second BIG, perform, via the communication circuitry, the first synchronization operation for the at least one BIS.

15. A non-transitory storage medium storing at least one instruction readable by a computer, wherein the at least one instruction, when executed by a processor including processing circuitry of an electronic device, causes the electronic device to perform at least one operation,
wherein the at least one operation comprises:
receiving information corresponding to a broadcast isochronous group (BIG) from an external electronic device,
storing the information related to the BIG,
based on the information corresponding to the BIG, performing a first synchronization operation for at least one broadcast isochronous stream (BIS) broadcast by the external electronic device,
based on receiving audio data, detecting a BIG asynchronous event corresponding to an asynchronous state for the BIG, and
based on the BIG asynchronous event, performing a second synchronization operation for the at least one BIS based on the stored information corresponding to the BIG.

16. The non-transitory storage medium of claim 15, wherein the at least one operation comprises:
based on a success of the second synchronization operation, receiving the audio data via the at least one BIS.

17. The non-transitory storage medium of claim 16, wherein the at least one operation comprises:
based on a failure of the second synchronization operation, receiving information corresponding to a second BIG from the external electronic device, and
based on the information corresponding to the second BIG, performing the first synchronization operation for the at least one BIS.

18. The non-transitory storage medium of claim 16, wherein the at least one operation comprises:
based on a failure of the second synchronization operation, identifying a number of synchronization operations performed by the electronic device; and
based on identifying the number of synchronization operations performed is less than a set number of times for performing the second synchronization operation, performing the second synchronization operation for the at least one BIS based on the stored information related to the BIG.

19. The non-transitory storage medium of claim 18, wherein the at least one operation comprises:
based on identifying that the number of synchronization operations performed by the electronic device is less than the set number of times for performing the second synchronization operation, receiving, from the external electronic device, information related to a second BIG while performing the second synchronization operation for the at least one BIS based on the stored information corresponding to the BIG; and
based on the information corresponding to the second BIG, performing the first synchronization operation for the at least one BIS.

20. The non-transitory storage medium of claim 18, wherein the at least one operation comprises:
based on identifying that the number of synchronization operations performed by the electronic device has reached the set number of times for performing the second synchronization operation, receiving, from the external electronic device, information related to a second BIG; and
based on the information related to the second BIG, performing the first synchronization operation for the at least one BIS.
